(19) United States
(12) Patent Application Publication
(10) Pub. No.: US 2025/0005618 A1
(43) Pub. Date: Jan. 2, 2025

(54) SYSTEMS AND METHODS FOR PRESENTATION OF MEDIA CONTENT TO MULTIPLE USERS

(71) Applicant: Adeia Guides Inc., San Jose, CA (US)

(72) Inventor: Mona Singh, Cary, NC (US)

(21) Appl. No.: 18/215,619

(22) Filed: Jun. 28, 2023

(51) Int. Cl. G06Q 30/0251; G06Q 50/00; H04N 21/258

(52) U.S. Cl. CPC G06Q 30/0252; G06Q 50/01; H04N 21/258

(57) ABSTRACT

Systems and methods are described for determining whether each of a first user and a second user has consumed a first media content item. In response to determining that each of the first and second users has consumed the first media content item, a predicted future interaction between the first user and the second user is determined. A second media content item is presented to each of the first and second users prior to the predicted future interaction. The second media content item comprises content relating to the first media content item.

### BACKGROUND

The present disclosure relates to methods and systems for presenting media content to multiple users. Particularly, but not exclusively, the present disclosure relates to the presentation of media content to multiple users prior to a predicted future interaction between the multiple users, e.g., so as to elicit communication between the multiple users about that media content during the predicted future interaction. The present disclosure also relates to methods and systems for selecting media content for presentation to multiple users prior to a predicted future interaction.

### SUMMARY

The manner in which media content is consumed has changed, e.g., as a result of Over-The-Top (OTT) services that allow users to consume media content as and when they choose. As a result, different users may have consumed different media content at different times. In some approaches, a user profile may store a record of the various media content consumed by a user. In other approaches, users may belong to various groups, such as social circles and/or work groups. As such, it would be beneficial to determine commonly consumed media content between users belonging to a group, such that information relating to the commonly consumed media content may be shared between users ahead of users belonging to that group interacting. Such an approach may help save time and effort, e.g., by facilitating an accurate exchange of information pertinent to both users and the media content that they have both consumed. Furthermore, it would be beneficial to this information exchange, e.g., from a system operation standpoint, if the users were reminded of the media content that they have consumed, e.g., prior to a predicted future interaction between users that have consumed the same or similar media content. Such a reminder may reduce operational load on a system, e.g., by minimizing user input or queries, during a predicted future interaction between users.

In some approaches, media content providers and content platforms may fail to understand which media content has been presented to which users, prior to a predicted future interaction between the users. Understanding such information may elicit communication between users about that media content during the predicted future interaction. In some cases, this communication may help improve user and/or system output that results from the predicted future interaction. Additionally, or alternatively, the communication may result in incentivizing users to further consume related media content and/or to consume products and services promoted by the media content.

Additionally, the present disclosure helps rationalize the flow of data (e.g., digital data) relating to media content, conveyed from and to various devices (e.g., users' media devices, servers, etc.) through various networks so as to reduce, for example, computational processing, buffer storage and network bandwidth use induced by the consumption of media content. To do so, various approaches are mentioned in the present disclosure such as criteria-based targeting of users so as to not forward media content indiscriminately, consumption of lower digital memory media content, control of the presentation frequency of media content, etc.

Methods and systems are provided herein for presenting media content items to multiple users (e.g., users apart from each other but not necessarily) prior to a predicted future interaction between the multiple users. A first media content item is caused to be presented to a first user and a second user. Whether each of the first and second users has consumed the first media content item is determined. In response to determining that each of the first and second users has consumed the first media content item, a predicted future interaction between the first user and the second user is determined. And, in response to determining the predicted future interaction between the first user and the second user, a second media content item is caused to be presented to each of the first and second users prior to the predicted future interaction, wherein the second media content item comprises content relating to the first media content item.

In some examples, the second media content item may be freshly “imprinted” in the respective minds of the first and second users prior to the predicted future interaction in order for first and second users to recall the first media content item prior to the predicted future interaction. Such recall may result in a few user inputs into the system, e.g., when discussing the media content item between users. For example, the first and second media content items may likely become one of the topics of the predicted future interaction, if not the primary topic.

A media content item contains graphical, video or audio information or a mixture thereof, that a user can consume and understand via their presentation. Media content items should be understood to mean an electronically consumable user media content item, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media posts, games, and/or any other media or multimedia and/or combination of the same.

In one scenario, the first and second media content items may be a primary ad (e.g., a full ad, a brand ad) and a reminder ad, respectively. A full ad is an ad that provides detailed information on a product or service (e.g., what it is, its purpose, benefits, usage, and any disclaimers). A brand ad is an ad that provides high-level information on a product or service to establish its brand (e.g., coolness factor, what kind of people use it). A reminder ad is a follow-on ad to a primary ad so as to elicit a memory of the primary ad in the viewer's mind. A reminder ad is generally much shorter than a full ad. Reminder ads may be for a new product or service, or an existing product or service. Reminder ads are created along with primary ads by the ad companies. The goal of reminder ads is to bring the product to the user's attention for the second or third time. Timing reminder ads is important because while a well-timed reminder ad can be the impetus for a user to buy a product, an ill-timed reminder ad may put users off from the product. Market research shows that 80% of sales require reminder ads. Accordingly, when the first and second media content items are a full ad and a reminder ad related to the full ad, respectively, the former and the latter share content.

In another scenario, the first media content item may be a movie and the second media content item may be a trailer for an upcoming sequel to the movie.

In another scenario, the first media content item may be a work product, such as a report or scientific paper, and the second media content item may be a recap or summary of the work product.

For the avoidance of doubt, the system and methods disclosed herein are not limited to the above instances, and the disclosed systems and methods may be implemented using any appropriate type of media content (such as those described above), in any appropriate scenario, where technically possible.

A predicted future interaction between the first user and the second user may be, for instance, an in-person meeting, determined by cross-referencing various information e.g., calendar data, geolocation data, search history, online comments, texts, emails, other communications (e.g., written, verbal or video communication) or any combination thereof, all those information being available in the first user information relating to the first user and the second user information relating to the second user. A predicted future interaction may be, for instance, a virtual meeting, determined by cross-referencing various information e.g., calendar data, virtual location data, search history, online comments, texts, emails, other communications (e.g., written, verbal or video communication) or any combination thereof, all those information being available in the first user information relating to the first user and the second user information relating to the second user. A predicted future interaction may be, for instance, the posting of online comments of one of the first and second users on a social media feed of the other one of the first and second users, determined by cross-referencing various information e.g., calendar data, geolocation data, virtual location data, search history, online comments, texts, emails, other communications (e.g., written, verbal or video communication) or any combination thereof, all those information being available in the first user information relating to the first user and the second user information relating to the second user. The online comments of one of the first and second users on a social media feed of the other one of the first and second users may be generated or not in response to a post present on the social media feed of the other one of the first and second users.

According to some implementations, methods and systems disclosed herein provide for an improved presentation of media content items to multiple users prior to a predicted future interaction. Causing a first media content item to be presented to a first user and a second user further comprises determining first user information relating to the first user and second user information relating to the second user. Additionally, causing a first media content item to be presented to a first user and a second user further comprises determining whether each of the first and second user information corresponds to a parameter of the first media content item. Furthermore, causing a first media content item to be presented to a first user and a second user further comprises in response to determining that each of the first and second user information corresponds to the parameter of the first media content item, determining the predicted future interaction based on the first and second user information.

Having first and second user information relating to first and second users, respectively match a parameter relating to the first content media item allows for targeting first and second users instead of having the first media content item to be indiscriminately presented to any users. The targeting of first and second users may require the use of several parameters present in the first and second user information relating to first and second users, respectively. The parameters relating to first media content item are selected based on identifying the characteristics of users that might be interested in consuming the first media content item. For instance, the parameters relating to first media content item may comprise at least one marketing criterion corresponding to the product or service promoted by the first media content item, when first and second media content items are a full ad and a reminder ad, respectively.

First user information relating to the first user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof. Similarly, second user information relating to the second user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof. Geolocation data in the real world relating to the first user, location data in any virtual world relating to the second user and future consumption of a media content item that could be interrupted to present first and/or second media content items to the first user may be used for contextual targeting of the first user so as to “plant” a media content item in specific locations in the real world and/or any virtual world, and during the future consumption of a media content item. Similarly, geolocation data in the real world relating to the second user, location data in any virtual world relating to the second user and future consumption of a media content item that could be interrupted to present first and/or second media content items to the second user may be used for contextual targeting of the second user so as to “plant” a media content item in specific locations in the real world and/or any virtual world, and during the future consumption of a media content item.

In some other implementations, causing a first media content item to be presented to a first user and a second user further comprises determining whether a trigger object is in a field of view of each of the first and second users. Additionally, causing a first media content item to be presented to a first user and a second user further comprises in response to determining that the trigger object is in the field of view of each of the first and second users, causing the first media content item to be presented to each of the first and second users.

This is an alternative way to target first and second users. Here, first and second users are targeted via the detection of a trigger object in the field of view of each of the first and second users, when first and second users wear an extended reality (XR) display. A XR display may be a Virtual Reality (VR) display or an Augmented Reality (AR) display. The targeting is based on the user's perception, via the XR display, of the immediate environment and/or the virtual graphical information generated by the projector of the XR display.

The trigger object may be a real object, a virtual object or a mixture thereof, perceived by a user via the XR display. This trigger object may be related either directly or indirectly to the first media content item. In the first case, it relates to the content of the first media content item. For example, if the first media content item is a full ad for a car, the trigger object may comprise a car. In the second case, the trigger object does not relate to the content of the first media content. The trigger object is then defined by an entity (e.g., ad platform) or a person. For instance, if the first media content item is a full ad for a car, the trigger object may be another transportation means (e.g., trains, planes, boats).

Alternatively, the first user may be targeted based on the matching between the parameter relating to first media content item and first user information relating to first user; and the second user wearing a XR display may be targeted based on the detection of a trigger object in the field of view of the second user.

In some implementations, determining the predicted future interaction between the first and second users further comprises determining first user information relating to the first user, wherein the first user information comprises at least one of calendar data, geolocation data or virtual location data of the first user, or online comments of the first user. In addition, determining the predicted future interaction between the first and second users further comprises determining second user information relating to the second user, wherein the second user information comprises at least one of calendar data, geolocation data or virtual location data of the second user or online comments of the second user. Moreover, determining the predicted future interaction between the first and second users further comprises determining the predicted future interaction based on the first and second user information.

In this way, by cross-referencing at least one of calendar data, geolocation data, virtual location data or online comments of the first user with at least one of calendar data, geolocation data, virtual location data or online comments of the second user, it is possible to predict a future interaction between the first user and the second user, and determine a predicted future interaction between the first user and the second user such that the location data and time data of the predicted future interaction are known with precision. The location data of the predicted future interaction may comprise geolocation data in the real world, location data in any virtual world or the content of social media feeds. The time data of the predicted future interaction may comprise start time and end time of the predicted future interaction. Other information contained in the first user information relating to the first user and the second user information relating to the second user may be utilized to predict a future interaction between the first user and the second user and determine the occurrence of a predicted future interaction between the first user and the second user as well as the location and time data related to the predicted future interaction: those information may be e.g., search history, texts, emails, other communications (e.g., written, verbal or video communication) or any combination thereof.

In some implementations, determining the predicted future interaction between the first and second users further comprises determining whether the first and second users each belong to a social circle based on the first and second user information. In addition, determining the predicted future interaction between the first and second users further comprises in response to determining that the first and second users each belong to the social circle, causing the second media content item to be presented to each of the first and second users prior to the predicted future interaction.

Having first and second users belong to a social circle increases the probability for first and second users to have a predicted future interaction in a near future. The first and second users may belong to the same social circle or different social circles that are connected through a number of other social circles. The lower the number of other social circles is, the likelier and the nearer in the future the predicted future interaction may occur.

In some implementations, causing the second media content item to be presented to each of the first and second users prior to the predicted future interaction further comprises determining a duration of the second media content item. Moreover, causing the second media content item to be presented to each of the first and second users prior to the predicted future interaction further comprises causing the second media content item to be presented to each of the first and second users at a first point in time spaced before the predicted future interaction by at least the duration.

In this way, the period between the time at which the consumption, by first and second users, of the second media content item is completed and the time at which the predicted future interaction starts may have a value in seconds comprised between zero and any number, depending on the location of the first point in time on a time axis. This period may be as close as possible to zero seconds in order to condition the minds of the first and second users (via the entire consumption, by first and second users, of the second media content item) right before the predicted future interaction. This results in eliciting communication between first and second users about the first and second media content items, and/or the products and services promoted by first and second media content items.

Alternatively, causing the second media content item to be presented to each of the first and second users prior to the predicted future interaction may further comprise causing the second media content item to be presented to each of the first and second users at a first point in time spaced before the predicted future interaction by at least a portion of the duration.

The first and second users may then partially consume the second media content item before having the predicted future interaction. The period between the time at which the partial consumption, by first and second users, of the second media content item is completed and the time at which the predicted future interaction starts may have a value in seconds comprised between zero and any number. This period may be as close as possible to zero seconds in order for conditioning the minds of the first and second users via the partial consumption of the second media content item right before the predicted future interaction.

In some implementations, causing the second media content item to be presented to each of the first user and the second user at the first point in time spaced before the predicted future interaction by at least the duration further comprises determining a first convenient point in time for the first user using the first user information, and a second convenient point in time for the second user using the second user information, wherein each of the first and second convenient points in time precedes the first point in time, and the first and second convenient points in time are different from each other. Additionally, causing the second media content item to be presented to each of the first user and the second user at the first point in time spaced before the predicted future interaction by at least the duration further comprises causing the second media content item to be presented to the first user at the first convenient point and to the second user at the second convenient point.

The first user is thus able to consume the second media content item, at the first convenient point in time, prior to the first point in time, that suits first user's schedule that may be derived from first user information. In a same manner, the second user is able to consume the second media content item, at the second convenient point in time, prior to the first point in time, that suits second user's schedule that may be derived from second user information.

In some implementations, causing the second media content item to be presented to the first user at the first convenient point in time and to the second user at the second convenient point in time further comprises determining a first window of time of the first user and a second window of time of the second user, each of the first and second windows of time having a start point and an end point in time. Additionally, causing the second media content item to be presented to the first user at the first convenient point in time and to the second user at the second convenient point in time further comprises determining a second point in time indicating a start of the predicted future interaction, wherein the end point of each of the first and second windows of time and the second point in time are all to match one another. Moreover, causing the second media content item to be presented to the first user at the first convenient point in time and to the second user at the second convenient point in time further comprises setting the first convenient point in time in between the start point of the first window of time and the first point in time and setting the second convenient point in time in between the start point of the second window of time and the first point in time.

In this way, the first window of time of the first user may correspond to a ratio of the distance of the first user from the predicted future interaction (e.g., in-person meeting, virtual meeting) to the velocity of the first user (e.g., velocity of the first user in the real world or in a virtual world). Similarly, the second window of time of the second user may correspond to a ratio of the distance of the second user from the predicted future interaction (e.g., in-person meeting, virtual meeting) to the velocity of the second user (e.g., velocity of the second user in the real world or in a virtual world). The first convenient point in time can be placed anywhere between the start point of the first window of time of the first user and the first point in time. In a same manner, the second convenient point in time can be placed anywhere between the start point of the second window of time of the second user and the first point in time. The first and second users may thus consume the second media content item at first and second convenient points in time, respectively (fitting their respective schedules) while moving towards a location in the real space corresponding to the predicted future interaction (if it is an in-person meeting between first and second users) or having the avatar of the first user and that of the second user move towards a location in a virtual space corresponding to the predicted future interaction (if it is a virtual meeting between first and second users).

In some implementations, causing the second media content item to be presented to each of the first and second users prior to the predicted future interaction further comprises determining, in response to determining that each of the first and second users has consumed the first media content item, a positive response of the first user and a positive response of the second user to the first media content item. Additionally, causing the second media content item to be presented to each of the first and second users prior to the predicted future interaction further comprises determining whether each of the positive response of the first user and the positive response of the second user has exceeded a positive response threshold. Furthermore, causing the second media content item to be presented to each of the first and second users prior to the predicted future interaction further comprises causing, in response to that each of the positive response of the first user and the positive response of the second user has exceeded the positive response threshold, the second media content item to be presented to each of the first and second users prior to the predicted future interaction.

Assessing the positive response of the first and second users and comparing it to a positive response threshold allows for determining whether first and second users are truly interested in the first media content item. Several technologies involving computers and sensors may be used either separately or in combination to implement the assessment of the positive response of the first and second users. Those technologies are listed hereafter.

Assessing the positive response of the first and second users may be implemented by monitoring the amount of times each of the first and second users has consumed the first media content item and whether or not each of the first and second users has interrupted the consumption of the first media content item. In this respect, the positive response threshold may be a minimum amount of times each of the first and second users should have consumed the first media content item without interrupting it.

Alternatively, or additionally, assessing the positive response of the first and second users may be implemented by monitoring whether each of the first and second users has consumed media content items whose respective content (e.g., media content, topic(s), objects present in the media content items) is related to that of the first media content item and determining the amount of those related media content items consumed by each of the first and second users. In this respect, the positive response threshold may be a minimum amount of related media content items each of the first and second users should have consumed prior to the consumption of the first media content item.

Alternatively, or additionally, assessing the positive response of the first and second users may be implemented by asking directly the feedback of first and second users. For example, first and second users may indicate each a satisfaction rating and the positive response threshold may be the average of the lowest rating and the highest rating, or a rating above the average.

Alternatively, or additionally, assessing the positive response of the first and second users may be implemented by having each of the first and second users click on a link related to the first media content item. In this case, the positive response threshold may be whether each of the first and second users has clicked or not on the link, or a minimum amount of times each of the first and second users has clicked on the link.

Alternatively, or additionally, assessing the positive response of the first and second users may be implemented by having a mouse cursor hovering over or near the first media content item. In this respect, the positive response threshold may be a minimum amount of time during which the mouse cursor hovers over or near the first media content item.

Alternatively, or additionally, assessing the positive response of the first and second users may be implemented by sensing whether each of the first and second users has scrolled back to the first media content item. In this case, the positive response threshold may be a minimum amount of times each of the first and second users should have scrolled back to the first media content item.

Alternatively, or additionally, assessing the positive response of the first and second users may be implemented by using sensors able to monitor the dilatation the pupils of first and second users. In this respect, the positive response threshold may be user-customized: the positive response threshold related to the first user may be the pupil size of the first user when the first user is requested to fix a point in an immediate environment that would trigger no response (a point in space e.g., a point in a wall); and the positive response threshold related to the second user may be the pupil size of the second user when the second user is requested to fix a point in an immediate environment that would trigger no response (a point in space e.g., a point in a wall).

Alternatively, or additionally, assessing the positive response of the first and second users may be implemented by using sensors able to track in real time the respective locations, targeted by the respective gazes of the first and second users, in the respective fields of view of the first and second users. In this respect, the positive response threshold may be a user-customized amount of time determined based on the consumption, by each of the first and second users, of a set of media content items they express interest in and of another set of media content items they disregard. The higher an amount of time a gaze of a user (e.g., first user, second user) is to target a location of a field of view of the user, the more likely the user is to be interested in the object present in the location.

Alternatively, or additionally, assessing the positive response of the first and second users may be implemented by using sensors able to determine the respective positions of the heads of each of the first and second users with respect to the first media content item and detect whether the heads of each of the first and second users are in position to consume the first media content item. In this respect, the positive response threshold may be a minimum amount of time the respective heads of each of the first and second users should spent in a given position allowing the consumption of the first media content item.

All the aforementioned sensors may be integrated into a XR display.

Alternatively, the second media content item may be presented to one of the first and second users prior to the predicted future interaction only if each of the first and the second users have positive reactions to the first media content item above the positive response threshold.

In some implementations, causing the first media content item to be presented to a first user and a second user further comprises setting a lifetime of the first media content item. Determining the predicted future interaction between the first user and the second user further comprises determining a plurality of predicted future interactions between the first user and the second user. Causing the second media content item to be presented to each of the first and second users prior to the predicted future interaction further comprises determining a time gap between each two successive predicted future interactions of the plurality of the predicted future interactions. In addition, causing the second media content item to be presented to each of the first and second users prior to the predicted future interaction further comprises mapping each predicted future interaction to each time gap, preceding and adjacent to each predicted future interaction. Furthermore, causing the second media content item to be presented to each of the first and second users prior to the predicted future interaction further comprises setting a presentation threshold related to the second media content item based on the lifetime of the first media content item. Additionally, causing the second media content item to be presented to each of the first and second users prior to the predicted future interaction further comprises determining whether each time gap exceeds the presentation threshold. Moreover, causing the second media content item to be presented to each of the first and second users prior to the predicted future interaction further comprises causing the second media content item to be presented to each of the first and second users prior to each predicted future interaction, wherein the mapped time gap exceeds the presentation threshold.

In this way, the presentation of the second media content item is limited by a presentation threshold based on the lifetime of the first media content item so as to not bore first and second users. Otherwise, the communication elicited from the predicted future interaction between first and second users may become derogatory with respect to first and second media content items.

In some implementations, causing the first media content item to be presented to each of the first and second users further comprises accessing a plurality of first media content items and determining first user information of the first user and second user information of the second user. Additionally, causing the first media content item to be presented to each of the first and second users further comprises determining whether each of the first and second user information corresponds to a parameter of each first media content item of the plurality of the first media content items. Moreover, causing the first media content item to be presented to each of the first and second users further comprises causing, in response to determining that each of the first and second user information corresponds to the parameter of each of the first media content of the plurality of the first media content items, each first media content item to be presented to each of the first and second users. Determining whether each of the first and second users has consumed the first media content item further comprises determining whether each of the first and second users has consumed each first media content item of the plurality of the first media content items. Determining a predicted future interaction between the first user and the second user further comprises determining a topic of the predicted future interaction. Causing a second media content item to be presented to each of the first and second users prior to the predicted future interaction further comprises determining a suitability score, with respect to the predicted future interaction, of each first media content item, that has been consumed by each of the first and second users, of the plurality of the first media content items, based on an alignment of each first media content item of the plurality of the first media content items with the topic of the predicted future interaction. In addition, causing a second media content item to be presented to each of the first and second users prior to the predicted future interaction further comprises comparing the suitability score of each consumed first media content item with each other. Moreover, causing a second media content item to be presented to each of the first and second users prior to the predicted future interaction further comprises determining the consumed first media content item exhibiting the highest suitability score. Furthermore, causing a second media content item to be presented to each of the first and second users prior to the predicted future interaction further comprises causing the second media content item to be presented to each of the first and second users, wherein the second media content item comprises content relating to the highest scoring first media content.

The determination of a suitability score, with respect to a predicted future interaction, of a first media content item, based on the alignment of the first media content item with the topic of the predicted future interaction allows for classifying a plurality of first media content items according to the alignment of each first media content item with the topic of the predicted future interaction. The highest scoring first media content item is to be the first media content item the best suited to be discussed during the predicted future interaction and to elicit communication between first and second users. Accordingly, a second media content item comprising content of the highest scoring first media content item is to be presented to first and second users prior to the predicted future interaction. For example, first and second content items may be a full ad and its related reminder ad.

Methods and systems are provided herein for selecting media content items to be presented to multiple users prior to a predicted future interaction between the multiple users. A plurality of first media content items is caused to be presented to a first user and a second user. Whether each of the first and second users has consumed each first media content item of the plurality of the first media content items is determined. In response to determining that each of the first and second users has consumed each first media content item of the plurality of the first media content item, a predicted future interaction between the first user and the second user is determined. In response to determining the predicted future interaction between first and second users, a topic of the predicted future interaction is determined. In response to determining the topic of the first interaction, a suitability score is determined, with respect to the predicted future interaction, of each first media content item, that has been consumed by each of the first and second users, of the plurality of the first media content items, based on an alignment of each first media content item of the plurality of the first media content items with the topic of the predicted future interaction. The consumed first media content item exhibiting the highest suitability score is determined. The second media content item is caused to be presented to each of the first and second users, wherein the second media content item comprises content relating to the highest scoring first media content.

The determination of a suitability score, with respect to a predicted future interaction, of a first media content item, based on the alignment of the first media content item with the topic of the predicted future interaction allows for classifying a plurality of first media content items according to the alignment of each first media content item with the topic of the predicted future interaction. The highest scoring first media content item is to be the first media content item the best suited to be discussed during the predicted future interaction and to elicit communication between first and second users. Accordingly, a second media content item comprising content of the highest scoring first media content item may be presented to first and second users prior to the predicted future interaction. For example, first and second content items may be a full ad and/or the reminder ad related to the full ad.

Methods and systems are provided herein for presenting media content items to multiple users (e.g., users apart from each other but not necessarily) prior to a predicted future interaction between the multiple users. Whether each of a first user and a second user has consumed a first media content item is determined. In response to determining that each of the first and second users has consumed the first media content item, a predicted future interaction between the first user and the second user is determined. And, in response to determining the predicted future interaction between the first user and the second user, a second media content item is caused to be presented to each of the first and second users prior to the predicted future interaction, wherein the second media content item comprises content relating to the first media content item.

In some examples, the first and second users could have consumed the first media content item independently (e.g., on their own and/or with the involvement of a third party), and they could still consume the second media content item prior to a predicted future interaction, during which communication about the first and second media content items will be elicited.

### BRIEF DESCRIPTION OF THE DRAWINGS

FIG. 1 depicts an overview of a system for presenting media content items to multiple users prior to a predicted future interaction in accordance with some implementations of the disclosure.

FIG. 2 illustrates an overview of a system for presenting media content items to multiple users prior to a predicted future interaction in accordance with some implementations of the disclosure.

FIG. 3 shows a flowchart representing a process for presenting media content items to users prior to a predicted future interaction in accordance with some implementations of the disclosure.

FIG. 4A-4C represent a flowchart describing a process for presenting media content items to users prior to a predicted future interaction in accordance with some implementations of the disclosure.

FIG. 5A-5B depict a flowchart describing a process for presenting media content items to users prior to a predicted future interaction in accordance with some implementations of the disclosure.

FIG. 6A-6B illustrate a flowchart describing a process for presenting media content items to users prior to a predicted future interaction in accordance with some implementations of the disclosure.

FIG. 7A exemplifies an overview of a typical process of presenting ads to multiple users.

FIG. 7B shows an overview of a process for presenting ads to multiple users prior to a predicted future interaction in accordance with some implementations of the disclosure.

FIG. 8 represents a sequence diagram, for a traditional media setting, performed by a system in accordance with some implementations of the disclosure.

FIG. 9 depicts a table compiling information saved on a social media server in accordance with some implementations of the disclosure.

FIG. 10 illustrates a process for selecting a reminder ad based on the nature of the related primary ad and the nature of the predicted future interaction between multiple users in accordance with some implementations of the disclosure.

FIG. 11 shows a flowchart describing a process for presenting multiple ads to multiple users prior to a predicted future interaction in accordance with some implementations of the disclosure.

FIG. 12 represents a table compiling examples of match between five users and three ads in accordance with some implementations of the disclosure.

FIG. 13 depicts a table compiling suitability scores of various ads at different hours in accordance with some implementations of the disclosure.

FIG. 14 illustrates a table compiling the best full ads based on the time considered, their lifetimes and their suitability scores in accordance with some implementations of the disclosure.

FIG. 15A shows a table compiling examples in which some reminder ads are not shown to users in accordance with some implementations of the disclosure.

FIG. 15B represents a table compiling other examples in which some reminder ads are not shown to users in accordance with some implementations of the disclosure.

FIG. 16 depicts a screen capture of a campaign manager on social media LinkedIn®.

FIG. 17 illustrates an example of possible integration of methods and systems for presenting ads to multiple users prior to a predicted future interaction on the social media app LinkedIn® in accordance with some implementations of the disclosure.

FIG. 18 shows a sequence diagram, for a social media setting, performed by a system in accordance with some implementations of the disclosure.

FIG. 19 shows a sequence diagram, for a XR setting, performed by a system in accordance with some implementations of the disclosure.

### DETAILED DESCRIPTION

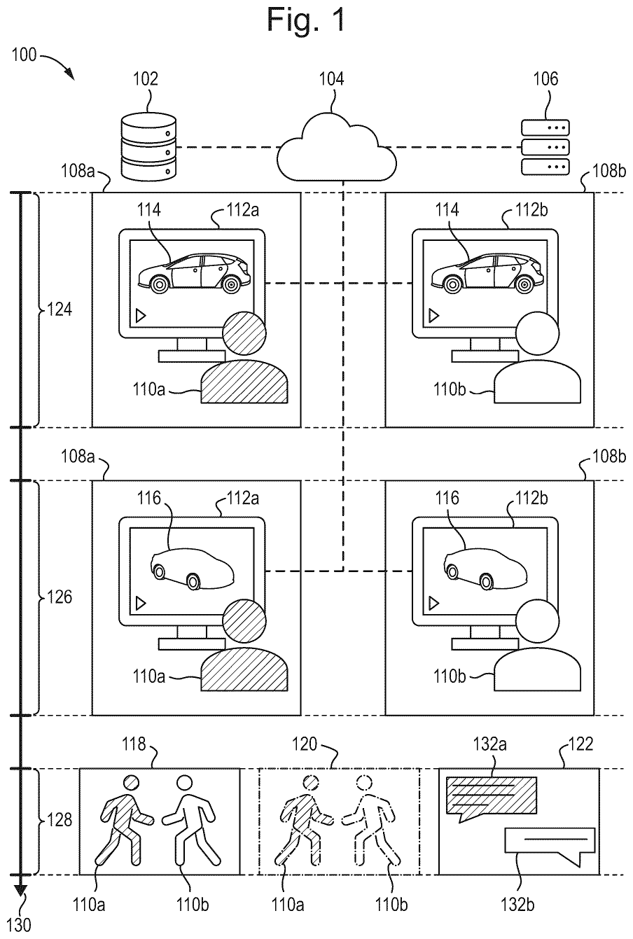

FIG. 1 depicts an overview of a system 100 for presenting media content items to multiple users prior to a predicted future interaction in accordance with some implementations of the disclosure. System 100 may include a content database 102, a network 104, a server 106, a device of a first user 112a, a device of a second user 112b. Devices 112a and 112b are configured to present media content items. Network 104 e.g., Internet is configured to communicatively couple devices 112a and 112b to one or more servers 104 and/or one or more content databases 106 from which media content items may be obtained for presentation. FIG. 1 is subdivided into three periods (e.g., a first period 124, a second period 126 and a third period 128) all arranged in sequence on a time axis 130, during which two users, a first user 110a and a second user 110b, are to consume media content items and exchange about them.

During first period 124, first and second users 110a and 110b, located in respective real-time locations 108a and 108b in the real space, are viewing a first media content item 114 on respective devices, device 112a and device 112b. During first period 124, first and second users 110a and 110b may view first media content item 114 at the same time (e.g., same time range) or at a different time (e.g., different time range). The notions of ‘same time’ and ‘different time’ are based on the selected timewise granularity. For instance, if a one-hour granularity is selected and the first and second users view the first media content item from 2:10 to 2:15 pm and from 2:30-2:36 pm, respectively, the first and second users will be deemed to have viewed the first media content item at the same time, in other words during the hour comprised between 2:00 and 3:00 pm. Respective real-time locations 108a and 108b in the real space of first and second users 110a and 110b may vary during first period 124. The term ‘media content item’ should be understood to mean an electronically consumable user media content item, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media posts, games, ads, and/or any other media or multimedia and/or combination of the same. First media content item 114 may be for instance a primary ad. First media content item 114 may be for instance a full ad promoting a product such as a car e.g., an electric SUV.

During second period 126 subsequent to first period 124, first and second users 110a and 110b, located in respective real-time locations 108a and 108b in the real space, are viewing a second media content item 116 on respective devices, device 112a and device 112b. Second media content item 116 contains content related to first media content item 114: first and second media content items 114 and 116 may be, for instance, a full ad and a reminder ad related to the primary ad, respectively. First and second media content items 114 and 116 may be, for example, a full ad and a related reminder ad, respectively, each promoting the same car e.g., an electric SUV. During second period 126, first and second users 110a and 110b may view second media content item 116 at the same time (e.g., same time range) or at a different time (e.g., different time range). The notions of ‘same time’ and ‘different time’ are based on the selected timewise granularity as mentioned earlier. Respective real-time locations 108a and 108b of first and second users 110a and 110b may vary during second period 126.

During third period 128 subsequent to second period 126, first and second users 110a and 110b have a predicted future interaction that may be, for instance, an in-person meeting 118, a virtual meeting 120 or an event 122 represented by the addition of online comments from one of first and second users onto the social media feed of the other one of first and second users. The predicted future interaction is determined by cross-referencing the first and second user information relating to first and second users, respectively. First user information relating to the first user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof. Similarly, second user information relating to the second user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof. In in-person meeting 118, first and second users are located in the same real-time location in the real space and exchange about first and second media content items 114 and 116 such that they become a topic of in-person meeting 118, if not the primary topic. In virtual meeting 120, first and second users 110a and 110b are located in a same real-time location in a virtual space and exchange about first and second media content items 114 and 116 such that they become a topic of virtual meeting 120, if not the primary topic.

In an example of event 122, first user 110a may post online comments 132a on a social media feed of first user 110a and second user 110b may add some online comments 132b related to the first user's online comments 132a on the first user's social media feed. The first user's online comments 132a and the second user's online comments 132b relate both to first and second media content items 114 and 116 such that they become a topic of event 122, if not the primary topic. In another example of event 122 (not shown on FIG. 1), second user 110b may simply post some online comments 132b on the social media feed of the first user 110a without being driven to do so by the posting of earlier online comments of the first user 110a.

During the predicted future interaction (e.g., in-person meeting 118, virtual meeting 120 or event 122), the timely generation for presentation of first and second media content items 114 and 116 prior to the predicted future interaction allows for promoting first and second media content items 114 and 116 as the topic or the primary topic of the predicted future interaction and to elicit communication about first and second media content items 114 and 116. The communication resulting from the predicted future interaction may likely result in incentivizing users to consume further first and second media content items 114 and 116 and/or to consume products and services promoted by first and second media content items 114 and 116. First and second users 110a and 110b may discuss about the electric SUV shown on first and second media content items 114 and 116.

From first to third periods 124-128, the device of first user 112a and the device 112b may be different or the same. If they are the same, first and second users are to view first and second media content items 114 and 116 at a different time as first and second users are to interact only during the predicted future interaction that occurs during third period 128.

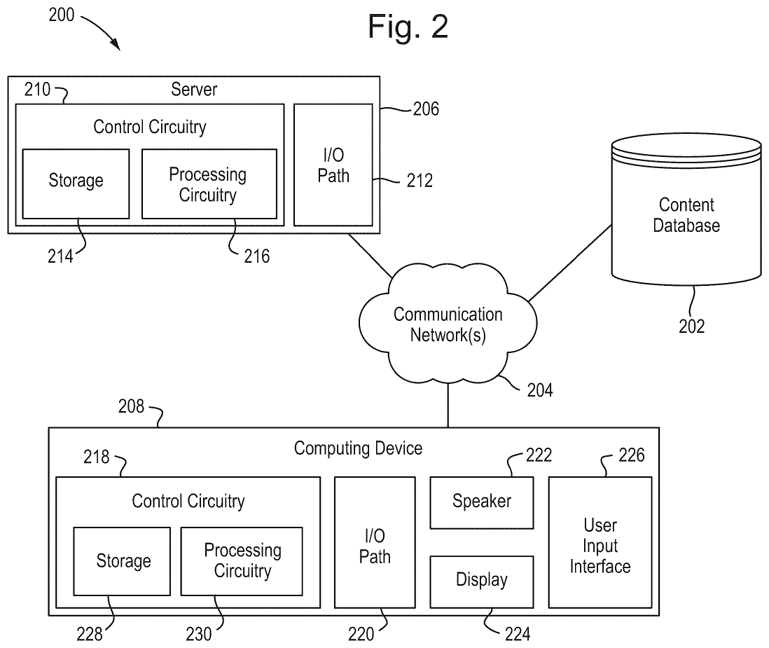

FIG. 2 is an illustrative block diagram showing example system 200 configured to present media content items to multiple users prior to a predicted future interaction. Although FIG. 2 shows system 200 as including a number and configuration of individual components, in some examples, any number of the components of system 200 may be combined and/or integrated as one device, e.g., device of the first user 112a and device of the second user 112b. System 200 includes content database 202 (e.g., content database 102), server 206 (e.g., server 106), and computing device 208, each of which is communicatively coupled to communication network 204, which may be the Internet or any other suitable network or group of networks. In some examples, system 200 excludes server 206, and functionality that would otherwise be implemented by server 206 is instead implemented by other components of system 200, such as computing device 208. In still other examples, server 206 works in conjunction with computing device 208 to implement certain functionality described herein in a distributed or cooperative manner.

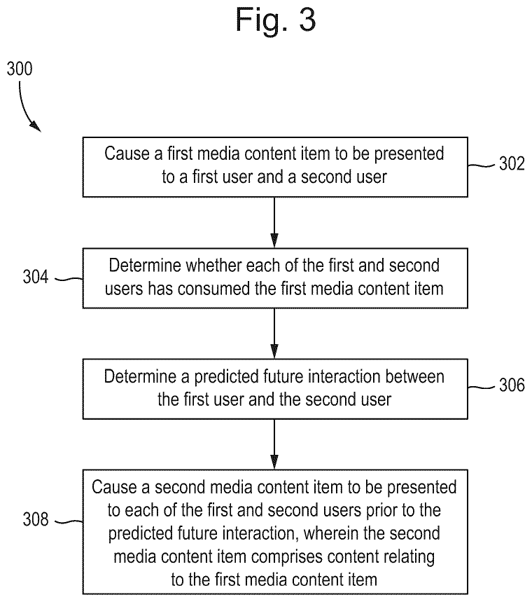

FIG. 3 shows a flowchart representing an illustrative process 300 for presenting media content items to multiple users prior to a predicted future interaction in accordance with some implementations of the disclosure. The process 300 allows for presenting two media content items (e.g., first and second media content items 114 and 116) to multiple users (e.g., first and second users 110a and 110b) at different points in time prior to the predicted future interaction (e.g., in-person meeting 118, virtual meeting 120 or posting of online comments as in event 122) between the multiple users (e.g., first and second users 110a and 110b). For the avoidance of doubt, the term “control circuitry” used in the below description applies broadly to the control circuitry outlined above with reference to FIG. 1 and/or FIG. 2. For example, control circuitry may comprise control circuitry of user device 112a/112b and control circuitry of server 106 (with reference to FIG. 1), and/or server 206 working either alone or in some combination with computing device 208.

At 302, control circuitry causes a media content item (e.g., first media content item 114) to be presented to multiple users (e.g., first and second users 110a and 110b).

At 304, control circuitry determines whether each of the multiple users (e.g., first and second users 110a and 110b) has consumed the media content item (e.g., first media content item 114).

At 306, control circuitry determines a predicted future interaction (e.g., in-person meeting 118, virtual meeting 120 or event 122) between the multiple users (e.g., first and second users 110a and 110b).

At 308, control circuitry causes another media content item (e.g., second media content item 116), to be presented to each of the multiple users (e.g., first and second users 110a and 110b) prior to the predicted future interaction (e.g., in-person meeting 118, virtual meeting 120 or posting of online comments as in event 122), wherein the other media content item (e.g., second media content item 116) comprises content related to the media content item (e.g., first media content item 114).

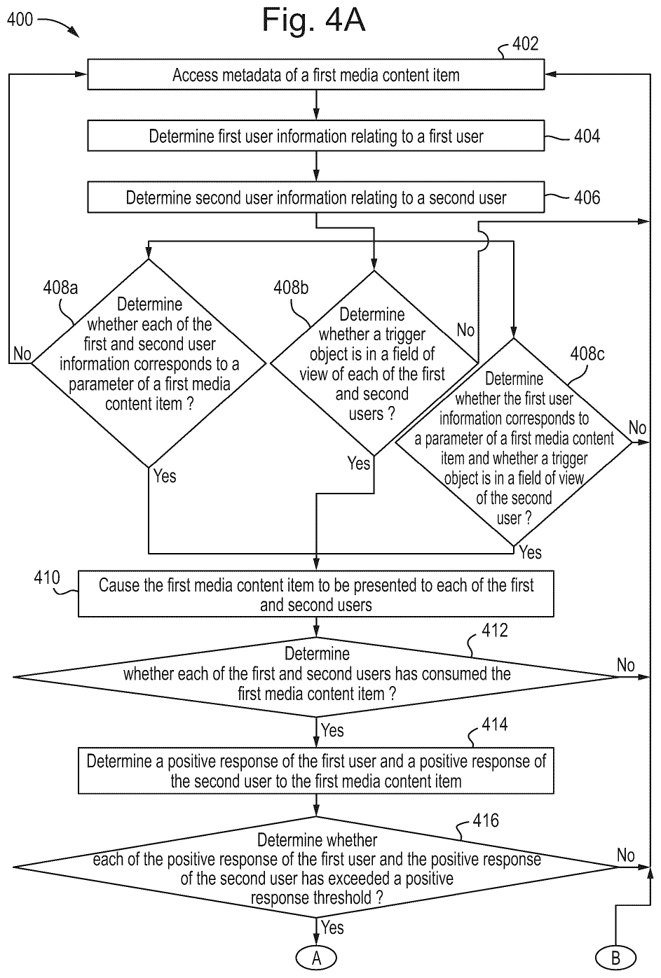

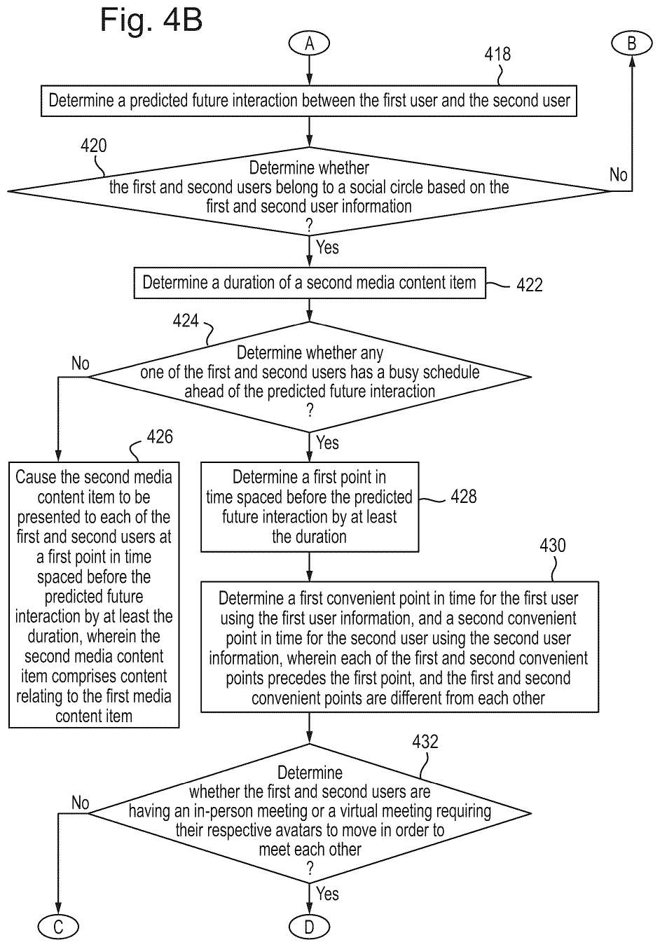

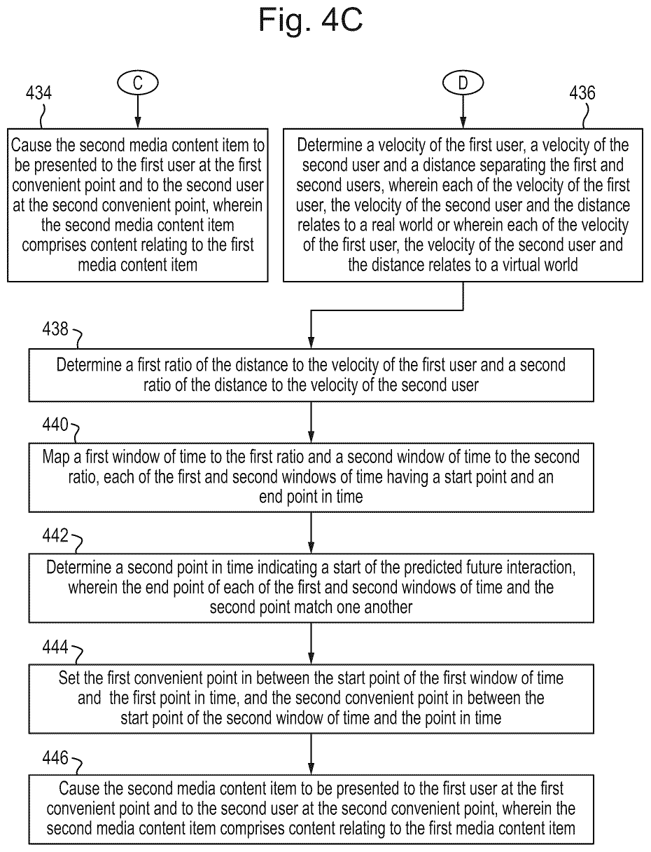

FIG. 4A-4C represent a flowchart describing a process 400 for presenting media content items to multiple users prior to a predicted future interaction in accordance with some implementations of the disclosure.

The process 400 allows for presenting two media content items (e.g., first and second media content items 114 and 116) to multiple users (e.g., first and second users 110a and 110b) prior to the predicted future interaction (e.g., in-person meeting 118, virtual meeting 120 or event 122) between the multiple users (e.g., first and second users 110a and 110b). At 402, control circuitry accesses metadata of a media content item (e.g., first media content item 114).

At 404, control circuitry determines user information of a user (e.g., first user information relating to the first user). User information relating to the user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof.

At 406, control circuitry determines another user information of another user (e.g., second user information relating to the second user). The other user information relating to the other user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof.

Three alternatives for targeting users (e.g., 408a, 408b and 408c) are then available. After selecting any one of the available alternatives, the fulfillment of a requirement for the selected alternative leads to 410 while the nonfulfillment leads back to 402. The alternatives 408b and 408c require the use of at least one XR display.

At 408a, control circuitry determines whether each of the user and other user information (e.g., first and second user information) corresponds to a parameter of the media content item (e.g., first media content item 114). The parameter of the media content item may relate to a marketing criterion (e.g., demographics, interests, socioeconomic status) so as to target multiple users (first and second users 110a and 110b) that might be interested in consuming the media content item (e.g., first media content item 114). If there is a match between the user information relating to the user and the parameter (e.g., marketing criterion) of the media content item (e.g., first media content item 114), then the user (e.g., first user 110a) may be interested in consuming the media content item (e.g., first media content item 114). The same applies to the other user (e.g., second user 110b).

At 408b, control circuitry determines whether a trigger object is in a field of view of each of the multiple users (e.g., first and second users 110a and 110b), each user wearing an XR display. The targeting is based on the user's perception, via the XR display, of the immediate environment and/or the virtual graphical information generated by the projector of the XR display. The trigger object may be a real object, a virtual object or a mixture thereof, perceived by a user via the XR display. This trigger object may be related either directly or indirectly to the media content item (e.g., first media content item 114). In the first case, it relates to the content of the media content item (e.g., first media content item 114). For example, if the media content item (e.g., first media content item 114) is a full ad for a car, the trigger object may comprise a car. In the second case, the trigger object does not relate to the content of the media content item (e.g., first media content 114). The trigger object is then defined by an entity (e.g., ad platform) or a person. For instance, if the media content item (e.g., first media content 114) is a full ad for a car, the trigger object may be another transportation means (e.g., trains, planes, boats).

At 408c, control circuitry determines whether the user information of the user (e.g., first user 110a) corresponds to a parameter of the media content item (e.g., first media content item 114) and whether a trigger object is in a field of view of the other user (e.g., second user 110b), the other user wearing an XR display. The user (e.g., first user 110a) is targeted following 408a while the other user (e.g., second user 110b) is targeted following 408b. The reverse situation is also possible.

At 410, control circuitry causes the media content item (e.g., first media content item 114) to be presented to each of the user and the other user (e.g., first and second users 110a and 110b).

At 412, control circuitry determines whether each of the user and other user (e.g., each of first and second users 110a and 110b) has consumed the media content item (e.g., first media content item 114). If it is the case, it leads to 414. If it is not the case, it leads back to 402.

At 414, control circuitry determines a positive response of the user (e.g., first user 110a) and a positive response of the other user (e.g., first user 110b). To do so, sensors to monitor the dilatation of the pupils of the user and the other user and/or to track the user's gaze and the other user's gaze may be used. (Several ways to assess the positive response of the first and second users disclosed in the summary of the present disclosure could be used at 414.)

At 416, control circuitry determines whether each of the positive response of the user (e.g., first user 110a) and the positive response of the other user (e.g., second user 110b) has exceeded a positive response threshold. If it is the case, the next step is 418. If it is not the case, the next step is 402. (Several ways to assess the positive response of the first and second users disclosed in the summary of the present disclosure could be used at 416.)

At 418, control circuitry determines a predicted future interaction between the user (e.g., first user 110a) and the other user (e.g., second user 110b), cross-referencing the user information relating to the user (e.g., first user information relating to first user 110a) and the other user information relating to the other user (e.g., second user information relating to second user 110b).

User information relating to the user (e.g., first user information relating to first user 110a) comprises at least one of calendar data, geolocation data, virtual location data or online comments. Similarly, the other user information relating to the other user (e.g., second user information relating to second user 110b) comprises at least one of calendar data, geolocation data, virtual location data or online comments.

The predicted future interaction may be for instance an in-person meeting (e.g., in-person 118), a virtual meeting (e.g., virtual meeting 120) or the posting of online comments (e.g., event 122) from one of the user (e.g., first user 110a) and the other user (e.g., second user 110b) on the social media feed of the other one of the user (e.g., first user 110a) and the other user (e.g., second user 110b). The posting of the online comments from one of the user and the other user may be motivated or not by prior online comments made by the other one of the user and the other user. The online comments comprise at least one of a video message, a voice message, a text message or a drawing.

At 420, control circuitry determines whether the user and the other user belong to a social circle based on the user information relating to the user and the other user information relating to the other user. By cross-referencing the user information relating to the user (e.g., first user 110a) and the other user information relating to the other user (e.g., second user 110b), the number of other social circles in between the social circle of the user (e.g., first user 110a) and the social circle of the other user (e.g., second user 110b) may be determined. The lower the number of other social circles in between the social circle of the user and the social circle of the other user is, the likelier and the nearer in the future the future reaction may occur.

At 422, control circuitry determines the duration of another media content item (e.g., second content item 116).

At 424, control circuitry determines whether any one of the user (e.g., first user 110a) and the other user (e.g., second user 110b) has a busy schedule ahead of the predicted future interaction. If it is not the case, the next step is 426. If it is the case, the next step is 428. One or both of the user (e.g., first user 110a) and the other user (e.g., second user 110b) might benefit to consume the other media content item (e.g., second media content item 116) at a respective convenient point in time fitting their respective schedules.

At 426, control circuitry causes the other media content item (e.g., second media content item 116) to be presented to each of the user (e.g., first user 110a) and the other user (second user 110b) at a first point in time spaced before the predicted future interaction by at least the duration, wherein the other media content item (e.g., second media content item 116) comprises content relating to the media content item (e.g., first media content item 114).

At 428, control circuitry determines a first point in time spaced before the predicted future interaction by at least the duration.

At 430, control circuit determines a first convenient point in time for the user (e.g., first user 110a) using the user information (e.g., first user information relating to first user), and a second convenient point in time for the other user (e.g., second user 110b) using the other user information (e.g., second user information relating to second user), wherein each of the first and second convenient points precedes the first point, and the first and second convenient points are different from each other.

At 432, control circuitry determines whether the user (e.g., first user 110a) and the other user (e.g., second user 110b) are having an in-person meeting (e.g., in-person meeting 118) or a virtual meeting that requires their respective avatars to move in order to meet each other (e.g., virtual meeting 120). If it is the case, then the next step is 434. If it is not the case, then the next step is 436.

At 434, control circuitry causes the other media content item (e.g., second media content item 116) to be presented to the user (e.g., first user 110a) at the first convenient point and to the other user (e.g., second user 110b) at the second convenient point, wherein the other media content item (e.g., second media content item 116) comprises content relating to the media content item (e.g., first media content item).

At 436, control circuitry determines a velocity of the user (e.g., first user 110a), a velocity of the other user (e.g., second user 110b) and a distance separating the user (e.g., first user 110a) and the other user (e.g., second user 110b), wherein each of the velocity of the user (e.g., first user 110a), the velocity of the other user (e.g., second user 110b) and the distance relates to a real world, or each of the velocity of the user (e.g., first user 110a), the velocity of the other user (e.g., second user 110b) and the distance relates to a virtual world.

At 438, control circuitry determines a first ratio of the distance to the velocity of the user (e.g., first user 110a) and a second ratio of the distance to the velocity of the other user (e.g., second user 110b).

At 440, control circuitry maps a first window of time to the first ratio and a second window of time to the second ratio, each of the first and second windows of time having a start point and an end point in time.

At 442, control circuitry determines a second point in time indicating a start of the predicted future interaction, wherein the end point of each of the first and second windows of time and the second point match one another.

At 444, control circuitry sets the first convenient point in between the start point of the first window of time and the first point in time, and the second convenient point in between the start point of the second window of time and the point in time.

At 446, control circuitry causes the other media content item (e.g., second media content item 116) to be presented to the user (e.g., first user 110a) at the first convenient point and to the other user (e.g., second user 110b) at the second convenient point, wherein the other media content item (e.g., second media content item 116) comprises content relating to the media content item (e.g., first media content item 114).

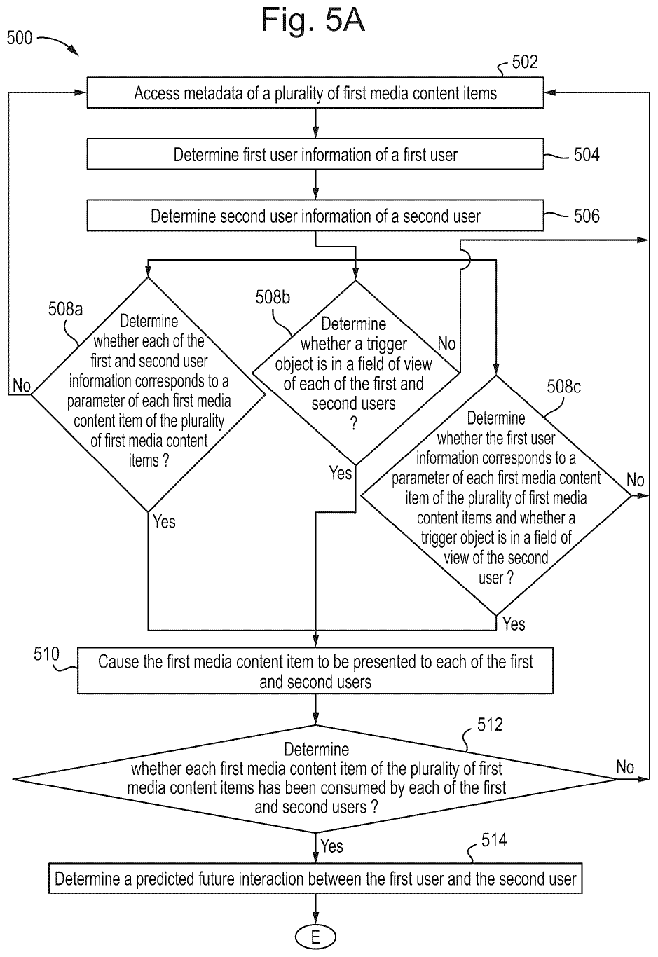

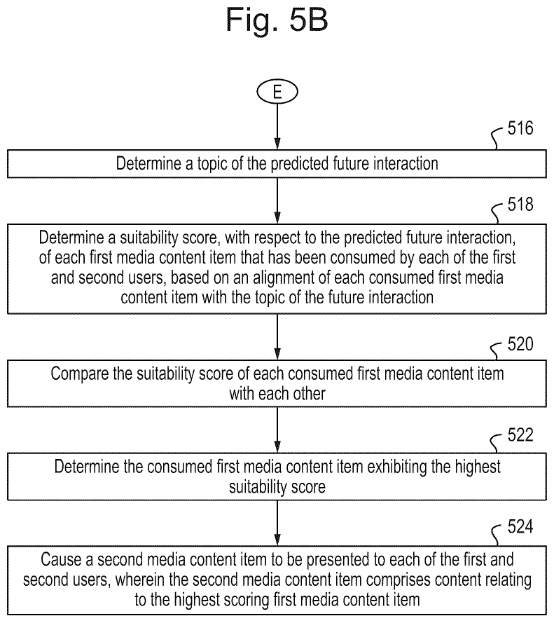

FIG. 5A-5B depict a flowchart describing a process for presenting media content items to users prior to a predicted future interaction in accordance with some implementations of the disclosure.

The process 500 allows for presenting two media content items (e.g., first and second media content items 114 and 116) to multiple users (e.g., first and second users 110a and 110b) prior to the predicted future interaction (e.g., in-person meeting 118, virtual meeting 120 or the posting of online comments such as in event 122) between the multiple users (e.g., first and second users 110a and 110b).

At 502, control circuitry accesses metadata of a plurality of media content items (e.g., plurality of first media content items). At 504, control circuitry determines user information of a user (e.g., first user information of the first user). User information relating to the user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof.

At 506, control circuitry determines another user information of another user (e.g., second user information of the second user). Other user information relating to the other user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof.

Three alternatives for targeting users (e.g., 508a, 508b and 508c) are then available. After selecting any one of the available alternatives, the fulfillment of a requirement for the selected alternative leads to 510 while the nonfulfillment leads back to 502. The alternatives 508b and 508c require the use of at least one XR display.

At 508a, control circuitry determines whether each of the user and other user information (e.g., first and second user information) corresponds to a parameter of each media content item of the plurality of media content items (e.g., plurality of first media content items). The parameter of each media content item of the plurality of media content items may relate to a marketing criterion (e.g., demographics, interests, socioeconomic status) so as to target multiple users (first and second users 110a and 110b) that might be interested in consuming each media content item of the plurality of media content items (e.g., plurality of first media content items). If there is a match between the user information relating to the user and the parameter (e.g., marketing criterion) of each media content item of the plurality of media content items (e.g., plurality of first media content items), then the user (e.g., first user 110a) may be interested in consuming each media content item (e.g., each first media content item of the plurality of first media content items). The same applies to the other user (e.g., second user 110b).

At 508b, control circuitry determines whether a trigger object is in a field of view of each of the multiple users (e.g., first and second users 110a and 110b), each user wearing an XR display. The targeting is based on the user's perception, via the XR display, of the immediate environment and/or the virtual graphical information generated by the projector of the XR display. The trigger object may be a real object, a virtual object or a mixture thereof, perceived by a user via the XR display. The trigger object may be related either directly or indirectly to each media content item of the plurality of media content items (e.g., each first media content item of the plurality of first media content items). In the first case, it relates to the content of each media content item of the plurality of the media content items (e.g., each first media content item of the plurality of first media content items). For example, if each media content item of the plurality of media content items (e.g., each first media content item of the plurality of first media content items) is a full ad for a car, the trigger object may comprise a car. In the second case, the trigger object does not relate to the content of each media content item of the plurality of media content items (e.g., each first media content item of the plurality of first media content items). The trigger object is then defined by an entity (e.g., ad platform) or a person. For instance, if the media content item (e.g., first media content 114) is a full ad for a car, the trigger object may be another transportation means (e.g., trains, planes, boats). Alternatively, each media content item of the plurality of media content items may be mapped to a respective trigger object.

At 508c, control circuitry determines whether the user information of the user (e.g., first user 110a) corresponds to a parameter of each media content item of the plurality of media content items (e.g., each first media content item of the plurality of first media content items) and whether a trigger object is in a field of view of the other user (e.g., second user 110b), the other user wearing an XR display. The user (e.g., first user 110a) is targeted following 508a while the other user (e.g., second user 110b) is targeted following 508b. The reverse situation is also possible.

At 510, control circuitry causes each media content item of the plurality of media content items (e.g., each first media content item of the plurality of first media content items) to be presented to each of the user (e.g., first user 110a) and the other user (e.g., second user 110b).

At 512, control circuitry determines whether each of the user (e.g., first user 110a) and other user (e.g., second user 110b) has consumed each media content item of the plurality of media content items (e.g., each first media content item of the plurality of first media content items). For each consumed media content item, the next step is 514. For each non-consumed media content item, the next step is 502.

At 514, control circuitry determines a predicted future interaction between the user (e.g., first user 110a) and the other user (e.g., second user 110b), cross-referencing the user information relating to the user (e.g., first user information relating to first user 110a) and the other user information relating to the other user (e.g., second user information relating to second user 110b).

User information relating to the user (e.g., first user information relating to first user 110a) comprises at least one of calendar data, geolocation data, virtual location data or online comments. Similarly, the other user information relating to the other user (e.g., second user information relating to second user 110b) comprises at least one of calendar data, geolocation data, virtual location data or online comments.
The predicted future interaction may be for instance an in-person meeting (e.g., in-person 118), a virtual meeting (e.g., virtual meeting 120) or the posting of online comments (e.g., event 122) from one of the user (e.g., first user 110a) and the other user (e.g., second user 110b) on the social media feed of the other one of the user (e.g., first user 110a) and the other user (e.g., second user 110b).
The posting of the online comments from one of the user and the other user may be motivated or not by prior online comments made by the other one of the user and the other user. The online comments comprise at least one of a video message, a voice message, a text message or a drawing.

At 516, control circuitry determines a topic of the predicted future interaction. To do so, control circuitry cross-references the user information of the user (e.g., first user information of the first user) and the other user information of the other user (e.g., second user information of the second user).

At 518, control circuitry determines a suitability score, with respect to the predicted future interaction, of each media content item (e.g., each first media content item) that has been consumed by each of the user (e.g., first user 110a) and the other user (e.g., second user 110b), based on an alignment of each consumed first media content item with the topic of the predicted future interaction.

At 520, control circuitry compares the suitability score of each consumed media content item (e.g., each first media content item) with each other.

At 522, control circuitry determines the consumed media content item exhibiting the highest suitability score.

At 524, control circuitry causes an other media content item to be presented to each of the user (e.g., first user 110a) and other user (e.g., second user 110b), wherein the other media content item (e.g., second media content item) comprises content relating to the highest scoring media content item (e.g., first media content item).

The highest scoring media content item (e.g., highest scoring first media content item) and the other content media content item (e.g., second media content item) may be a full ad and its reminder ad.

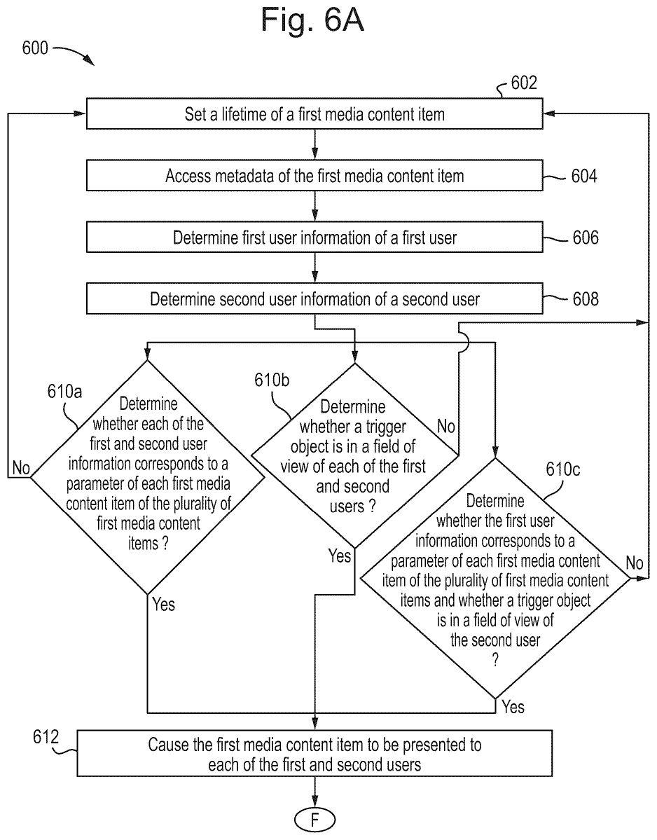

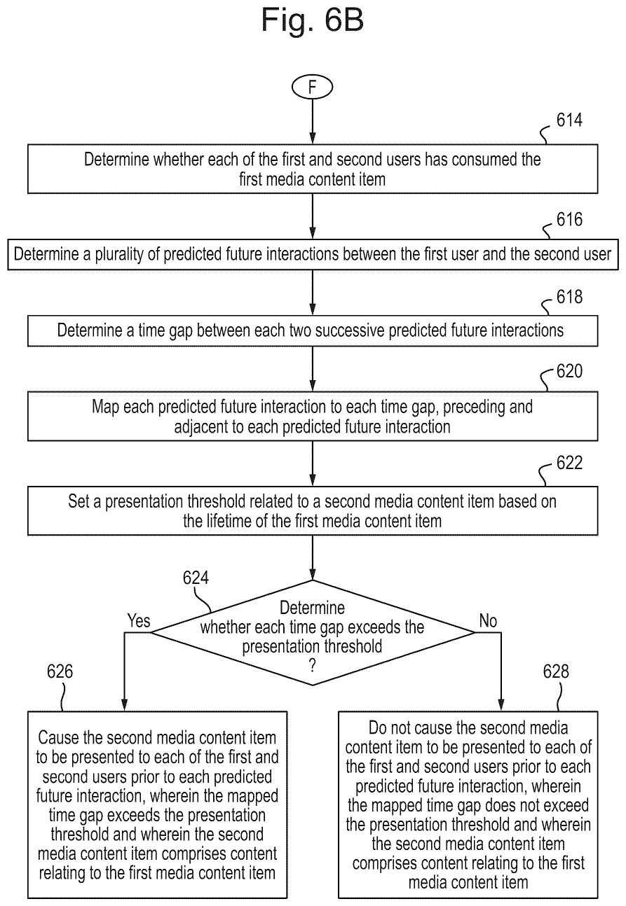

FIGS. 6A-6B illustrate a flowchart describing a process 600 for presenting media content items to users prior to a predicted future interaction in accordance with some implementations of the disclosure.

At 602, control circuitry sets a lifetime of a media content item (e.g., first media content item 114).

At 604, control circuitry accesses metadata of the media content item (e.g., first media content item 114).

At 606, control circuitry determines user information of a user (e.g., first user information of the first user). User information relating to the user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof.

At 608, control circuitry determines another user information of another user (e.g., second user information of the second user). The other user information relating to the other user may comprise demographics, interests, socioeconomic status, search history, geolocation data in the real world, location data in any virtual world, calendar data, future consumption of a media content item that could be interrupted to present first and/or second media content items, online comments, texts, emails, other communications (e.g., written, verbal or video communication), or any combination thereof.

Three alternatives for targeting users (e.g., 610a, 610b and 610c) are then available. After selecting any one of the available alternatives, the fulfillment of a requirement for the selected alternative leads to 612 while the nonfulfillment leads back to 602. The alternatives 610b and 610c require the use of at least one XR display.

At 610a, control circuitry determines whether each of the user and other user information (e.g., first and second user information) corresponds to a parameter of the media content item (e.g., first media content item 114). The parameter of the media content item may relate to a marketing criterion (e.g., demographics, interests, socioeconomic status) so as to target multiple users (first and second users 110a and 110b) that might be interested in consuming the media content item (e.g., first media content item 114). If there is a match between the user information relating to the user and the parameter (e.g., marketing criterion) of the media content item (e.g., first media content item 114), then the user (e.g., first user 110a) may be interested in consuming the media content item (e.g., first media content item 114). The same applies to the other user (e.g., second user 110b).

At 610b, control circuitry determines whether a trigger object is in a field of view of each of the multiple users (e.g., first and second users 110a and 110b), each user wearing an XR display. The targeting is based on the user's perception, via the XR display, of the immediate environment and/or the virtual graphical information generated by the projector of the XR display.

The trigger object may be a real object, a virtual object or a mixture thereof, perceived by a user via the XR display. This trigger object may be related either directly or indirectly to the media content item (e.g., first media content item 114). In the first case, it relates to the content of the media content item (e.g., first media content item 114). For example, if the media content item (e.g., first media content item 114) is a full ad for a car, the trigger object may comprise a car. In the second case, the trigger object does not relate to the content of the media content item (e.g., first media content 114). The trigger object is then defined by an entity (e.g., ad platform) or a person. For instance, if the media content item (e.g., first media content 114) is a full ad for a car, the trigger object may be another transportation means (e.g., trains, planes, boats).

At 610c, control circuitry determines whether the user information of the user (e.g., first user 110a) corresponds to a parameter of the media content item (e.g., first media content item 114) and whether a trigger object is in a field of view of the other user (e.g., second user 110b), the other user wearing an XR display. The user (e.g., first user 110a) is targeted following 610a while the other user (e.g., second user 110b) is targeted following 610b. The reverse situation is also possible.

At 612, control circuitry causes the media content item (e.g., first media content item 114) to be presented to each of the user (e.g., first user 110a) and the other user (e.g., second user 110b).

At 614, control circuitry determines whether each of the user (e.g., first user 110a) and other user (e.g., second user 110b) has consumed the media content item (e.g., first media content item 114). If it is the case, it leads to 616. If it is not the case, it leads back to 602.

At 616, control circuitry determines a plurality of predicted future interactions between the user (e.g., first user 110a) and the other user (e.g., second user 110b), cross-referencing the user information relating to the user (e.g., first user information relating to first user 110a) and the other user information relating to the other user (e.g., second user information relating to second user 110b). User information relating to the user (e.g., first user information relating to first user 110a) comprises at least one of calendar data, geolocation data, virtual location data or online comments. Similarly, the other user information relating to the other user (e.g., second user information relating to second user 110b) comprises at least one of calendar data, geolocation data, virtual location data or online comments.

Each of the predicted future interactions may be for instance an in-person meeting (e.g., in-person 118), a virtual meeting (e.g., virtual meeting 120) or the posting of online comments (e.g., event 122) from one of the user (e.g., first user 110a) and the other user (e.g., second user 110b) on the social media feed of the other one of the user (e.g., first user 110a) and the other user (e.g., second user 110b). The posting of the online comments from one of the user and the other user may be motivated or not by prior online comments made by the other one of the user and the other user.
The online comments comprise at least one of a video message, a voice message, a text message or a drawing.

At 618, control circuitry determines a time gap between each two successive predicted future interactions.

At 620, control circuitry maps each predicted future interaction to each time gap, preceding and adjacent to each predicted future interaction.

At 622, control circuitry sets a presentation threshold related to another media content (e.g., second media content item 116) based on the lifetime of the media content item (e.g., first media content item 114).

At 624, control circuitry determines whether each time gap exceeds the presentation threshold. If it is the case, the next step is 626. If it is not the case, the next step is 628.

At 626, control circuitry causes the other media content item (e.g., second media content item 116) to be presented to each of the user (e.g., first user 110a) and the other user (e.g., second user 110b) prior to each predicted future interaction (e.g., in-person meeting 118, virtual meeting 120, posting of online comments such as event 122), wherein the mapped time gap exceeds the presentation threshold and wherein the other media content item (e.g., second media content item 116) comprises content relating to the media content item (e.g., first media content item 114).

At 628, control circuitry does not cause the other media content item (e.g., second media content item 116) to be presented to each of the user (e.g., first user 110a) and the other user (e.g., second user 110b) prior to each predicted future interaction (e.g., in-person meeting 118, virtual meeting 120, posting of online comments such as event 122), wherein the mapped time gap exceeds the presentation threshold and wherein the other media content item (e.g., second media content item 116) comprises content relating to the media content item (e.g., first media content item 114).

Advertisements are a major source of income for media providers and platforms. The same can be expected for XR platforms (e.g., AR or VR platforms), as those become established. Media consumption and XR advertisements are based on the user's demographics and behaviors. While humans are heavily influenced by others, media and XR advertising platforms consider a user's social circle; however, they do not synchronize the ads within the user's social circle.

In a traditional media setting, users might consume media together (such as a sporting event). Then, ads could be shown to multiple users. Though the ads weren't targeted precisely, by showing them to multiple users, ad agencies could attempt to generate a buzz for their products.

In OTT and XR settings, there are no common media because the user's experiences are largely independent of each other. An exception is in a multiplayer AR game when users are in the same space together. But that case is like the previous case of traditional media (watching a sporting event together). In OTT and XR settings, the users see different things at different times, they may be consuming entirely different media and advertisements and they may evolve on the same type of platforms or on different types of platforms. Nothing has be done so far to coordinate the consumption of ads by multiple users based on a predicted future interaction, irrespective of the nature of the settings in which the multiple users evolve.

This disclosure provides an exemplary method to present reminder ads in such a way that they are timed for eliciting communication between users. The first, a full ad, is displayed to users based on the marketing criteria but reminder ads are timed just in time for a communication between users in a social circle who share the particular topic of interest. The intelligent timing ensures that the ad is on the top of the users' minds when they have an opportunity to communicate with each other.

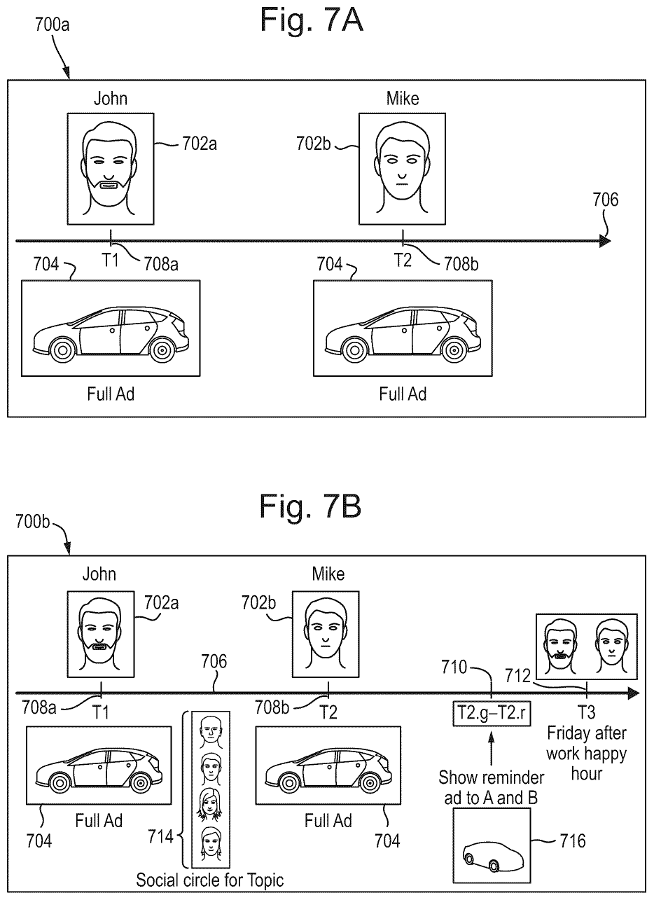

FIG. 7A exemplifies an overview of a typical process 700a of presenting ads to multiple users. Consider John 702a and Mike 702b, two friends who live in San Jose, California area. Each of them has an interest in purchasing an electric SUV. Their tastes overlap a little in terms of luxury, but they may have different preferences regarding performance and legroom. Among the various companies selling cars, Compagnie A is trying to reach this market for its new model, a seven-seater electric SUV. Compagnie A's ad agency has bought ads with various media platforms. Before the present disclosure, John and Mike are shown a full ad 704 for Compagnie A's new model at different times 708a and 708b (which are located on a time scale 706), based on criteria such as demographics, interests, and search history (which they satisfy). However, they may or may not remember the ad when they meet each other.

It would be in Compagnie A's interest if John and Mike were to discuss its new model and assure each other of its many good features and capabilities so they can be comfortable making such a large purchase. It would also be in John and Mike's interest to have an occasion to discuss the vehicle before making a major purchase that they will own for many years.

FIG. 7B shows a process 700b for presenting ads to multiple users prior to a predicted future interaction in accordance with some implementations of the disclosure. John 702a is shown a full ad 704 for Compagnie A's new model. The system implementing process 700b determines the social circle 714 that shares the topic with him. The system implementing process 700b determines all contacts are socially connected with John 720a. It prioritizes showing full ad 704 to Mike 702b when Mike 702b satisfies or partially satisfies the parameter for full ad 704. Once both John 702a and Mike 702b have been shown the ad at different times 708a and 708b, the system determines when they are next going to interact (based on their calendars, predictions of their geospatial location, the likelihood of interaction in social media, and other virtual interactions). The system implementing process 700b then provides reminder ads 716 to John and Mike at time 710 close to their expected time of predicted future interaction 712. In this way, the system implementing process 700b can lead them to a discussion of the advertised product by refreshing the ad in their minds at the right time.

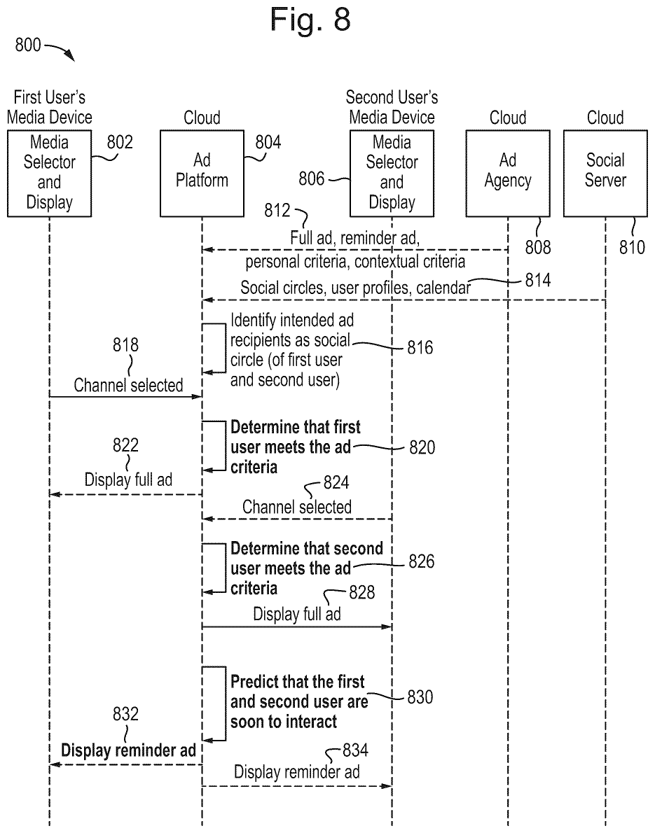

FIG. 8 represents a sequence diagram, for a traditional media setting, performed by a system 800 in accordance with some implementations of the disclosure. System 800 may comprise a first media and selector display 802 (e.g., first user's media device, the device 112a of first user 110a), a second media and selector display 806 (e.g., second user's media device, the device 112b of second user 110b), an ad platform 804, an ad agency 808 and a social media server 810, which are all communicatively coupled via a network. Ad platform 804, ad agency 808 and social media server 810 are all cloud-based.

In step 812, ad agency 808 forwards full ads (e.g., first media content item 114, full ad 704), reminder ads (e.g., second media content item 116, reminder ad 716) and various marketing criteria (e.g., personal criteria, contextual criteria) relating to full ads, to ad platform 804.

In step 814, social media server 810 dispatches user information (e.g., user profiles, social circles, user calendars) relating to multiple users (e.g., first user 110a, second user 110b, John 702a and Mike 702b) to ad platform 804.

In step 816, ad platform 804 identifies intended ad recipients (e.g., first and second users 110a and 110b, John 702a and Mike 702b, social circles of first and second users and social circles of John and Mike). For instance, once a user satisfies a marketing criterion relating to a full ad, the user's social circle is also probed so as to determine which users of the user's social circle do satisfy the same marketing criterion too. Social media server 810 keeps track of users in the first user's social circle.

In step 818, first media and selector display 802 selects a channel via an input of a user (e.g., first user 110a, John 702a).

In step 820, ad platform 804 determines whether user information relating to a user (e.g., first user 110a, John 702a) comprises at least one parameter matching a marketing criterion relating to the full ad (e.g., first media content item 114, full ad 704).

In step 822, ad platform 804 forwards full ad (e.g., first media content item 114, full ad 704) to first media and selector display 802 (e.g., first user's media device) so as to be displayed on the channel previously selected.

Similarly, in step 824, second media and selector display 806 selects a channel via an input of another user (e.g., second user 110b, Mike 702b).

In step 826, ad platform 804 determines whether user information relating to the other user (e.g., second user 110b, Mike 702b) comprises at least one parameter matching a marketing criterion relating to the full ad (e.g., first media content item 114, full ad 704).

In step 828, ad platform 804 forwards full ad (e.g., first media content item 114, full ad 704) to second media and selector display 806 (e.g., second user's media device) so as to be displayed on the channel previously selected.

In step 830, ad platform 804 determines whether multiple users (e.g., first user 110a and second user 110b, John 702a and Mike 702b) are to have a predicted future interaction (e.g., in-person meeting 118, virtual meeting 120, posting of online comments such as event 122).

In steps 832 and 834, ad platform 804 dispatches a reminder ad (e.g., second media content item 116, reminder ad 716) to both first and second media and selector displays 802 and 806 so as to be displayed on the channels previously selected, prior to the predicted future interaction. The reminder ad may be displayed at the same time or at a different time on first and second media and selector displays 802 and 806.

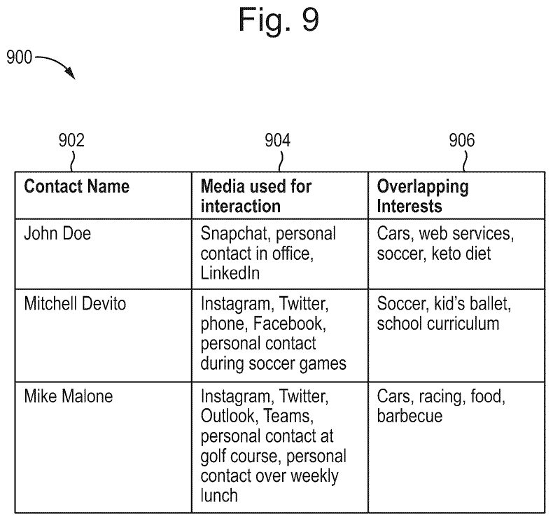

FIG. 9 depicts a table 900 compiling information (e.g., contact name 902, media used for interaction 904, overlapping interests 906) saved on a social media server (e.g., social media server 810) according to some implementations of the disclosure. The social media server (e.g., social media server 810) also keeps track of the user profiles, social circles, and user calendars.

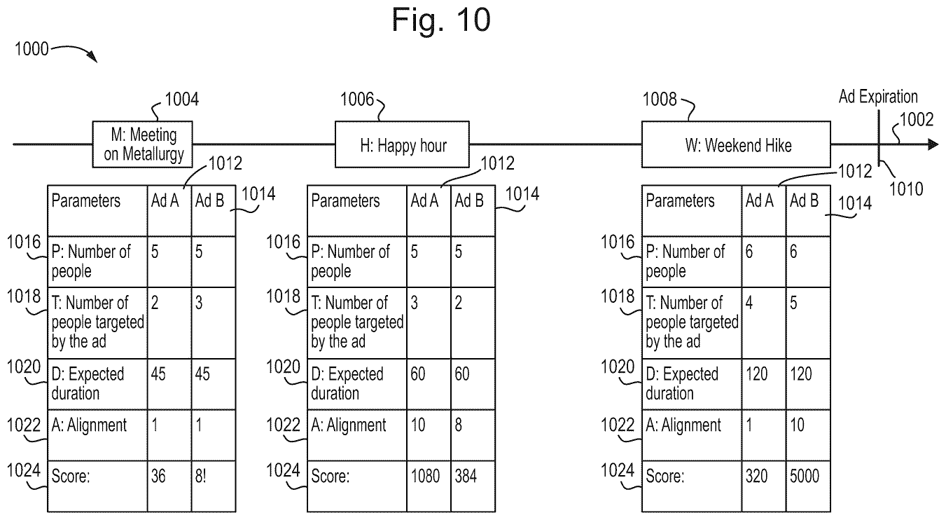

FIG. 10 illustrates a process 1000 for selecting a reminder ad (e.g., second media content item 116, reminder ad 716) based on the nature of the related primary ad (e.g., first media content item 114, full ad 704) and the nature of the predicted future interaction (e.g., in-person meeting 118, virtual meeting 120, posting of online comments such as event 122) between multiple users (e.g., first user 110a and second user 110b, John 702a and Mike 702b, social circle 714 of John 720a), in accordance with some implementations of the disclosure.

The calendar entries or predictions are based on past behaviors, or messaging apps like text, email, etc. Calendar events may be interpreted from social media apps through events. For example, if there is an event that two users have signed up for via these apps then it is likely that they will go to it.

To determine the best suited reminder ad to the predicted future interaction, a suitability score S 1024 is calculated, for example, using the following formula: S=(T²*D*A)/P where T, D, A and P stand for the number of people 1018 targeted by the ad and who are present during the predicted future interaction, the expected duration 1020 of the predicted future interaction, the alignment 1022 of the topic of the predicted future interaction with the content of the given full ad, and the number of people 1016 that is to attend the predicted future interaction, respectively.

In general, if ‘P’ is large then the opportunity for two people to talk about a particular topic is lower than in predicted future interactions where there are fewer people. The people attending can be determined from a calendar entry (how many people RSVP'd Yes for an event) or from their emails or text messages. Doing so may be realized through individual events (such as on social media or gaming platforms) without revealing the entire calendar of the user. ‘T’ is computed based on the personal matching criteria provided by the ad agency along with information from user profiles of the people attending the event. ‘D’ can be determined from a calendar entry or from their emails, interest in a social media post, or text messages. ‘A’ can be determined by comparing logs of previous meetings of a certain type with ad content. For example, if the weekly hike chats have turned to shoes, they would align with an ad that talks about boots. A regular meeting on metallurgical engineering may involve topics such as steel girders and tensile strength, which are closer to the topic of bridge construction than boots and web services.

Here are the following assumptions to arrive at the above mathematical formula of the suitability score ‘S’ 1024:
as the number of targeted people goes up the ad becomes more valuable. Because people are likely to interact with each other, the value of the ad is proportional to T²;
as the duration of a predicted future interaction goes up, there is an increased opportunity for discussions;
as the alignment of the topic of the predicted future interaction with the ad goes up the discussion of the ad becomes more likely;
and as the number of people (including those who are not targeted by the ad) goes up there is an increased chance of other discussions. Thus, the value of the ad is reduced in larger crowds.

The suitability score is computed for each predicted future interaction up to the expiration time of the ads. An ad expires at the time after which the ad is not being offered by the ad agency. For example, if an ad is for a sale on Black Friday, there is no reason to show it after Black Friday. The expiration time refers to the minimum expiration of all ads being currently considered, so that ads that are near expiration are prioritized for display.

In FIG. 10, there are three predicted future interactions 1004, 1006 and 1008 positioned at different times on a time axis 1002, prior to the expiration time 1010 of two full ads, Ad A 1012 and Ad B 1014. The earliest predicted future interaction 1006 is a meeting on metallurgy. The subsequent predicted future interaction 1006 is a happy hour meeting and the last predicted future interaction 1008 is a weekend hike. Suitability scores ‘S’ 1024 of Ad A 1012 and Ad B 1014, with respect to the three predicted future interactions 1004, 1006 and 1008 are then calculated by determining ‘T’ 1018, ‘D’ 1020, ‘A’ 1022 and ‘P’ 1016. The highest suitability score indicates the full ad best suited for a considered predicted future interaction. Accordingly, a reminder ad (related to the best suited full ad as it comprises content of the best suited full ad) will be forwarded to the targeted people.

For instance, based on the calculations, Ad B 1014 promoting shoes is determined to be the best suited for display before the weekend hike and before the meeting on metallurgy, and Ad A 1012 promoting a car is determined to be the best suited for display before the happy hour.

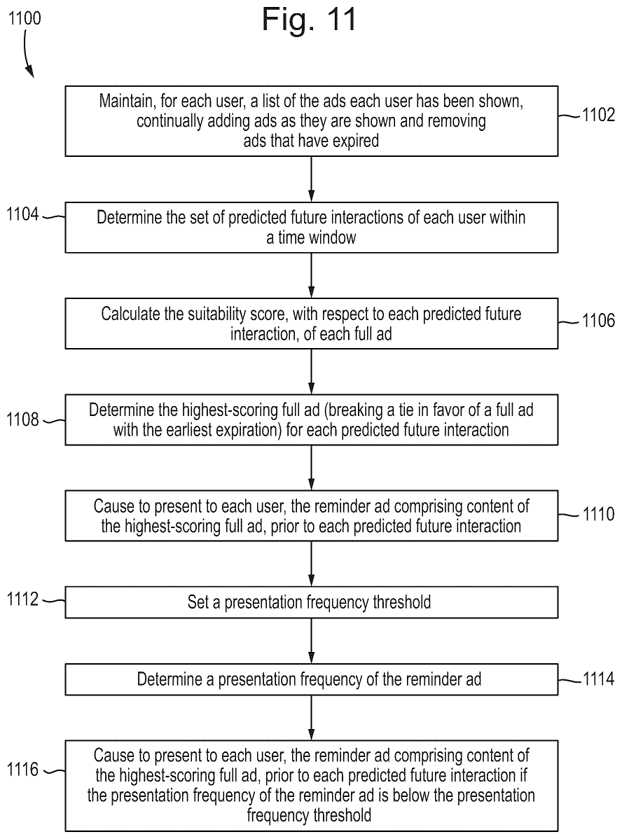

FIG. 11 shows a flowchart describing a process 1100 for presenting multiple ads to multiple users prior to a predicted future interaction in accordance with some implementations of the disclosure.

At 1102, control circuitry maintains, for each user, a list of the ads each user has been shown, continually adding ads as they are shown and removing ads that have expired. At 1104, control circuitry determines the set of predicted future interactions of each user within a time window. At 1106, control circuitry calculates the suitability score, with respect to each predicted future interaction, of each full ad. At 1108, control circuitry determines the highest-scoring full ad (breaking a tie in favor of a full ad with the earliest expiration) for each predicted future interaction. At 1110, control circuitry causes to present to each user, the reminder ad comprising content of the highest-scoring full ad, prior to each predicted future interaction.

At 1112, control circuitry sets a presentation frequency threshold. The presentation frequency threshold is intended to avoid overloading each user with the same reminder ad. Otherwise, each user might respond negatively to the reminder ad at some point. At 1114, control circuitry determines a presentation frequency of the reminder ad. At 1116, control circuitry causes to present to each user, the reminder ad comprising content of the highest-scoring full ad, prior to each predicted future interaction, if the presentation frequency of the reminder ad is below the presentation frequency threshold.

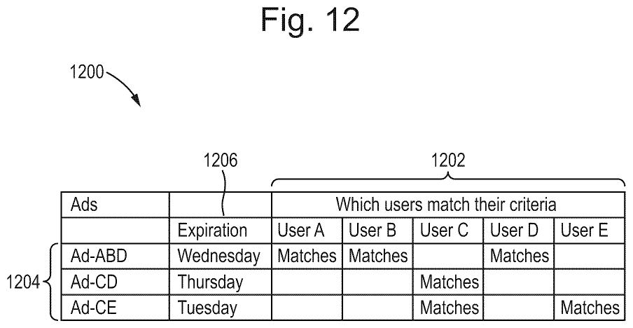

Some embodiments may feature multiple users and multiple ads (e.g., FIGS. 12, 13, 14, 15A and 15B.) For instance, assuming there are five users (User A, User B, User C, User D, User E) and three ads (Ad-ABD expiring Wednesday midnight, Ad-CD expiring Thursday 8:00 PM, and Ad-CE expiring Tuesday 7:30 PM), the users match the criteria of the ads as follows:
Ad-ABD: User A, User B, and User D.
Ad-CD: User C and User D.
Ad-CE: User C and User E

FIG. 12 represents a table 1200 compiling examples of targeting match between five users 1202 (User A, User B, User C, User D and User E) and three full ads 1204 (Ad-ABD, Ad-CD and Ad-CE), in accordance with some implementations of the disclosure. (For instance, a targeting match between a media content item and a user is illustrated in steps 408a, 408b, 408c, 508a, 508b, 508c, 610a, 610b and 610c.) The three full ads have each an expiration date 1206.

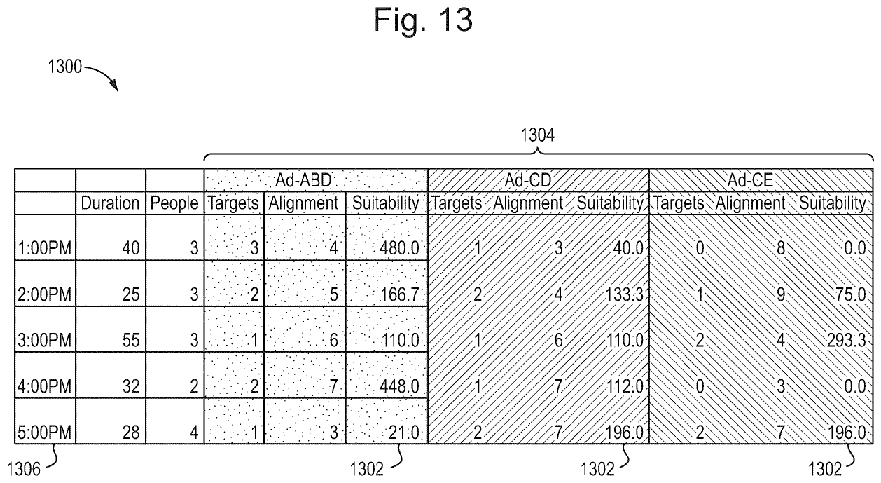

Imagine that it is Tuesday morning (Refer to FIG. 13). There are five predicted future interactions all on Tuesday at 1:00 PM, 2:00 PM, 3:00 PM, 4:00 PM, and 5:00 PM. For each predicted future interaction, the parameters P, D, T and A are known such that a suitability score for each ad can be calculated. The results are compiled in FIG. 13.

FIG. 13 depicts a table 1300 compiling suitability scores 1302 of the above three full ads 1304 (Ad-ABD, Ad-CD and Ad-CE) at different hours 1306 in accordance with some implementations of the disclosure.

For each user, the full ad the best suited for each predicted future interaction exhibits the highest suitability score. If some full ad have the same suitability scores, ties are broken in favor of ads that have an earlier expiration time.

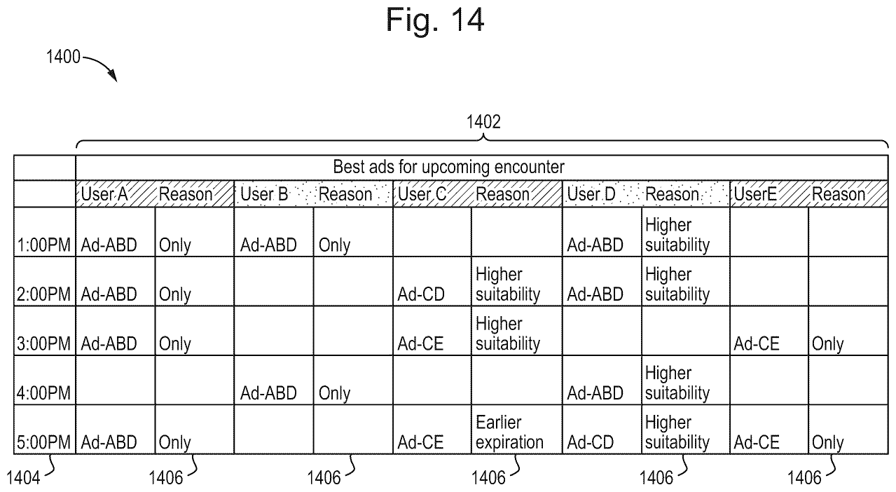

FIG. 14 illustrates a table 1400 compiling the best full ads for each of the above five users 1402 (User A, User B, User C, User D and User E) based on the time considered 1404, the lifetimes of the ads and their suitability scores in accordance with some implementations of the disclosure. Table 1400 comprises a column 1406 for each user to justify why the indicated full ad is the best full ad. FIG. 14 results from combining the data of the tables shown in FIGS. 12 and 13.

Table 1400 of FIG. 14 shows what full ads are best suited for what user and what predicted future interaction depending on the time. A reminder ad related to the highest scoring full ad for a given time is to be shown to specific users prior to the predicted future interaction.

User A, User B, and User E have only one matching full ad each, so if they are present in a predicted future interaction, their matching full ad for that predicted future interaction is the best full ad. Therefore,
The User A column contains Ad-ABD in any predicted future interaction where User A is present.
The User B column contains Ad-ABD in any predicted future interaction where User B is present.
The User E column contains Ad-CE in any predicted future interaction where User E is present.

User C and User D have two full ads each, so there is a choice of which full ad to show them based on the suitability scores of the full ads (and in case of a tie, based on the expiration time). Therefore,
The User C column contains
   2:00 PM: Ad-CD because it has a higher suitability score than Ad-CE
   3:00 PM: Ad-CE because it has a higher suitability score than Ad-CD
   5:00 PM: Ad-CE because it has the same suitability score as Ad-CD, but an earlier expiration
The User D column contains
   1:00 PM: Ad-ABD because it has a higher suitability score than Ad-CD
   2:00 PM: Ad-ABD because it has a higher suitability score than Ad-CD
   4:00 PM: Ad-ABD because it has a higher suitability score than Ad-CD
   5:00 PM: Ad-CD because it has a higher suitability score than Ad-ABD

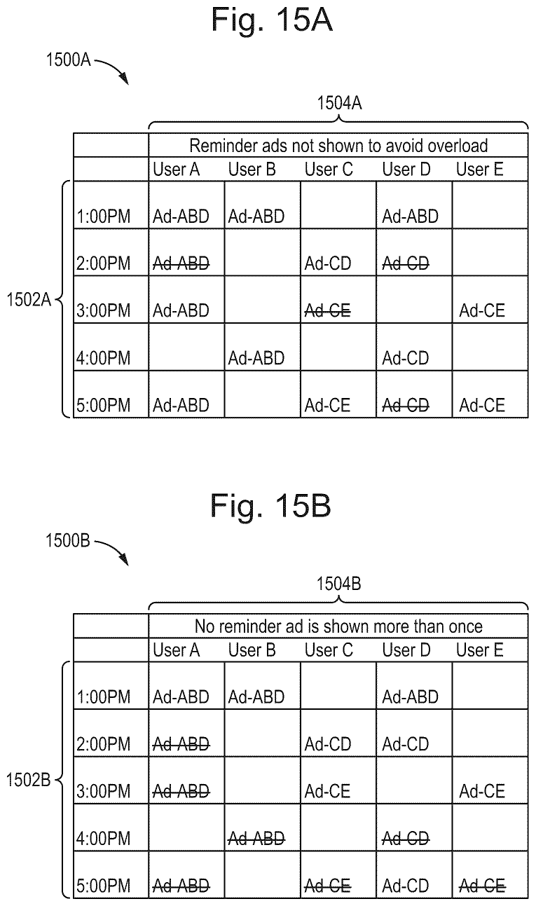

FIG. 15A shows a table 1500A compiling examples in which some reminder ads at a given time 1502A are not shown to the above five users 1504A (User A, User B, User C, User D and User E) in accordance with some implementations of the disclosure. In addition, the load on users is to be limited so as to not show reminder ads too often. Therefore, some reminder ads that could have been shown are not shown. Below, reminder ads are not shown in consecutive slots. For example, because User A is shown a reminder ad before the 1:00 PM predicted future interaction, User A is not shown another reminder ad before the 2:00 PM predicted future interaction (and after the previous reminder ad). Consequently,.
Prior to the 1:00 PM predicted future interaction: User A, User B, and User D will be shown Ad-ABD: all of them are present and can initiate conversations with each other.
Prior to the 2:00 PM predicted future interaction: User C will be shown Ad-CD and User D is shown nothing. User C can initiate a conversation with User D.
Prior to the 3:00 PM predicted future interaction: User A will be shown Ad-ABD and User E will be shown Ad-CE. User A has no one to talk to at the predicted future interaction (User B and User D are both absent) but the predicted future interaction is so well-aligned with Ad-ABD that it is still helpful-and there is nothing better matching to advertise.
Prior to the 4:00 PM predicted future interaction: User B will be shown Ad-ABD and User D will be shown Ad-CD. User A can initiate a conversation with User D about Ad-ABD. User D is not expected to initiate a conversation at the predicted future interaction (User C is absent) but the predicted future interaction is so well-aligned with Ad-CD that it is still helpful.
Prior to the 5:00 PM predicted future interaction: User A will be shown Ad-ABD and User E will be shown Ad-CE. User A can initiate a conversation with User D. User C and User E will be shown Ad-CE, which can prompt them to initiate a conversation with each other.

FIG. 15B represents a table 1500B compiling other examples in which some reminder ads at given time 1502B are not shown to the above five users 1504B (User A, User B, User C, User D and User E) in accordance with some implementations of the disclosure. An alternative approach is to show distinct ads on the same day. Since all the predicted future interactions are on the same day, no ad is repeated within these predicted future interactions.

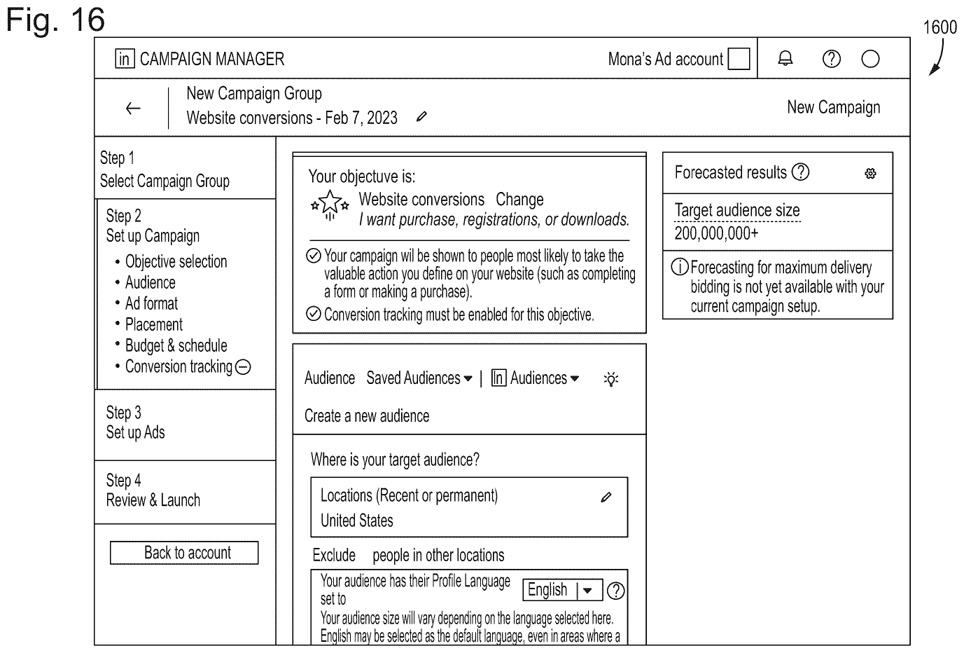

FIG. 16 depicts a screen capture of a campaign manager 1600 on LinkedIn®. The present disclosure could be used to make this user interface richer. Specifically, an option, to the campaign manager, to specify elements of the present disclosure, including the audience (e.g., users connected via social circles) and the fact that reminder ads are to be shown prior to predicted future interactions between targets of the related full ad.

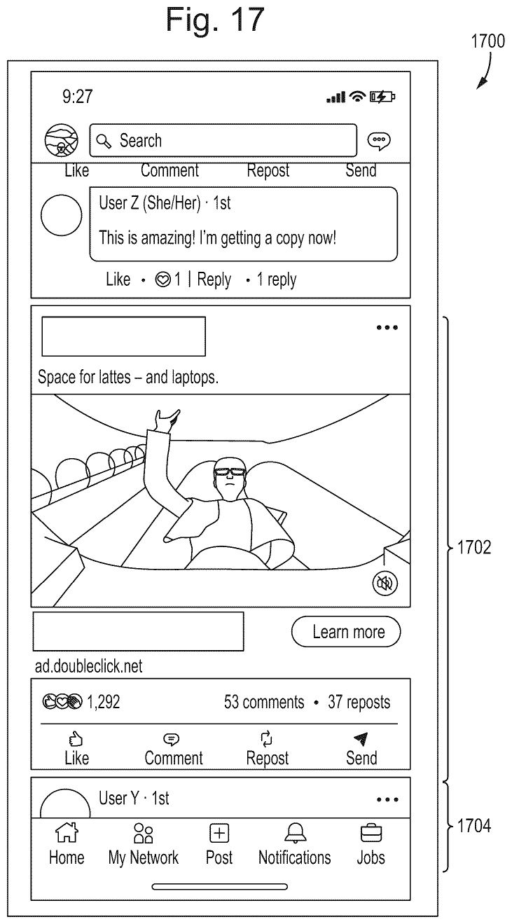

In one example, the predicted future interaction may be on a social media app. For instance, consider a case (See FIG. 17) where the user (User X) and her contact (User Y) match the marketing criteria for a full ad of a car manufacturer promoting cars. Both users are shown the full ad of the car manufacturer. Both users are identified as being socially connected. Both users are predicted to have a virtual interaction because User Y has already a post on the social media app LinkedIn® that appears in User X's LinkedIn® feed 1700. A reminder ad 1702 related to the full ad of the car manufacturer is then presented before the post 1704 by User Y. FIG. 17 exemplifies the placement of reminder ad 1702 in User X's LinkedIn® feed 1700 prior to User Y's post 1704. In effect, FIG. 17 illustrates an example of possible integration of methods and systems for presenting ads to multiple users prior to a predicted future interaction on the social media app LinkedIn® in accordance with some implementations of the disclosure.

In another example, User Y's post may be about electric vehicles. In that case, the reminder ad becomes even more relevant for the predicted future interaction embodied by User Y's post. This relates to the alignment of the topic.

In cases where User X has already made a comment on User Y's post, the likelihood of predicted future interaction increases compared to a first-time viewing of a post. This is because as people engage in a post they get more and more interested in the dialogue and are like to come back and get updates and comments by others.

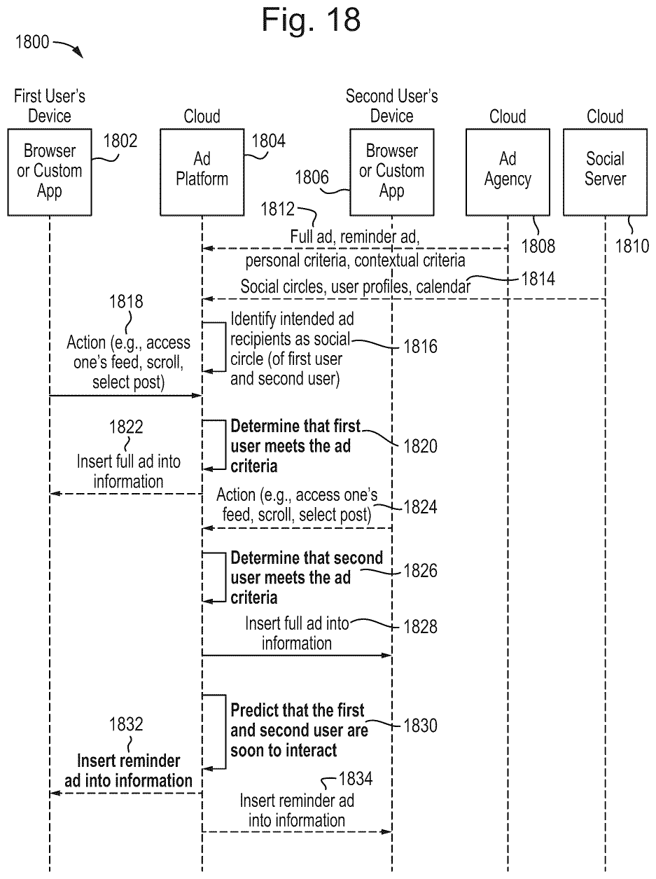

FIG. 18 shows a sequence diagram, for a social media setting, performed by a system 1800 in accordance with some implementations of the disclosure. A predicted future interaction in this case is a post on which users may respond. The predicted future interaction is a virtual asynchronous interaction. For example, commenting on a tweet or a shared post. The suitability score S follows the following mathematical formula: S=(T²*R*A)/P where T, R, A and P stand for the number of people who are being targeted by the ad and who have commented on the post, the rate at which comments are coming for the post, alignment of the topics of the predicted future interactions with the content of the given ad and the number of people who have commented on a post. A higher rate indicates that there is more excitement about the post.

System 1800 may comprise a first browser or custom app 1802 (e.g., first user's media device), a second browser or custom app 1806 (e.g., second user's media device), an ad platform 1804, an ad agency 1808 and a social media server 1810, which are all communicatively coupled via a network. Ad platform 1804, ad agency 1808 and social media server 1810 are all cloud-based.

In step 1812, ad agency 1808 forwards full ads (e.g., first media content item 114, full ad 704), reminder ads (e.g., second media content item 116, reminder ad 716) and various marketing criteria (e.g., personal criteria, contextual criteria) relating to full ads, to ad platform 1804.

In step 1814, social media server 1810 dispatches user information (e.g., user profiles, social circles, user calendars) relating to multiple users (e.g., first user 110a, second user 110b, John 702a and Mike 702b) to ad platform 1804.

In step 1816, ad platform 1804 identifies intended ad recipients (e.g., first and second users 110a and 110b, John 702a and Mike 702b, social circles of first and second users and social circles of John and Mike). For instance, once a user satisfies a marketing criterion relating to a full ad, the user's social circle is also probed so as to determine which users of the user's social circle do satisfy the same marketing criterion too. Social media server 1810 keeps track of users in the first user's social circle.

In step 1818, first browser or custom app 1802 accesses a feed of a user (e.g., first user 110a, John 702a), scrolls it and selects a post via user inputs.

In step 1820, ad platform 1804 determines whether user information relating to a user (e.g., first user 110a, John 702a) comprises at least one parameter matching a marketing criterion relating to the full ad (e.g., first media content item 114, full ad 704).

In step 1822, ad platform 1804 forwards full ad (e.g., first media content item 114, full ad 704) to first browser or custom app 1802 (e.g., first user's media device) so as to be inserted into information.

Similarly, in step 1824, second browser or custom app 1806 accesses a feed of another user (e.g., second user 110b, Mike 702b), scrolls it and selects a post via user inputs.

In step 1826, ad platform 1804 determines whether user information relating to the other user (e.g., second user 110b, Mike 702b) comprises at least one parameter matching a marketing criterion relating to the full ad (e.g., first media content item 114, full ad 704).

In step 1828, ad platform 1804 forwards full ad (e.g., first media content item 114, full ad 704) to second browser or custom app 1806 (e.g., second user's media device) so as to be inserted into information.

In step 1830, ad platform 1804 determines whether multiple users (e.g., first user 110a and second user 110b, John 702a and Mike 702b) are to have a predicted future interaction (e.g., in-person meeting 118, virtual meeting 120, event 122).

In steps 1832 and 1834, ad platform 1804 dispatches a reminder ad (e.g., second media content item 116, reminder ad 716) to both first and second browsers or custom apps 1802 and 1806 so as to be inserted into information, prior to the predicted future interaction. The reminder ad may be displayed at the same time or at a different time on first and second browsers or custom apps 1802 and 1806.

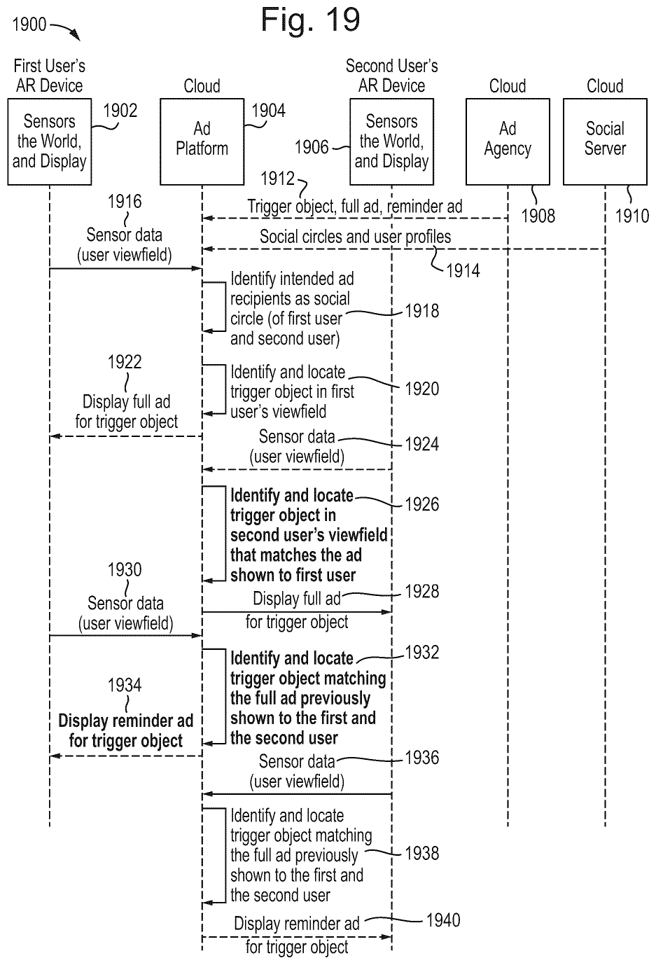

FIG. 19 shows a sequence diagram, for a XR setting, performed by a system 1900 in accordance with some implementations of the disclosure.

System 1900 may comprise a first sensors equipped XR display 1902 (e.g., first user's XR device), a second sensors equipped XR display 1906 (e.g., second user's XR device), an XR ad platform 1904, an ad agency 1908 and a social media server 1910, which are all communicatively coupled via a network. Ad platform 1904, ad agency 1908 and social media server 1910 are all cloud-based.

In step 1912, ad agency 1908 forwards full ads (e.g., first media content item 114, full ad 704), reminder ads (e.g., second media content item 116, reminder ad 716) and the identity of trigger objects relating to full ads, to ad platform 1904.

In step 1914, social media server 1910 dispatches user information (e.g., user profiles, social circles, user calendars) relating to multiple users (e.g., first user 110a, second user 110b, John 702a and Mike 702b) to ad platform 1904.

In step 1916, first sensors equipped XR display 1902 (e.g., first user's XR device) forwards sensor-collected data relating to the user's field of view (e.g., first user 110a's field of view) to ad platform 1904.

In step 1918 (which is an optional step), ad platform 1904 identifies intended ad recipients (e.g., first and second users 110a and 110b, John 702a and Mike 702b, social circles of first and second users and social circles of John and Mike). For instance, once a user satisfies a marketing criterion relating to a full ad, the user's social circle is also probed so as to determine which users of the user's social circle do satisfy the same marketing criterion too. Social media server 1910 keeps track of users in the first user's social circle. Step 1918 is an optional step as the presentation of the full ad and the related reminder ad to the user and the other user is based on the user's perception of having the trigger object in the user's field of view and the other user's perception of having the trigger object in the other user's field of view, respectively. The selection of target users based on step 1918 could be implemented before or after the trigger object-based selection in order to increase selectivity.

In step 1920, ad platform 1904 identifies and locates a trigger object relating to a full ad in the user's field of view (e.g., first user 110a's field of view).

In step 1922, first sensors equipped XR display 1902 displays the full ad (e.g., first media content item 114, full ad 704) matching the trigger object, to the user (e.g., first user 110a, John 702a).

In step 1924, second sensors equipped XR display 1906 (e.g., second user's XR device) forwards sensor-collected data relating to the other user's field of view (e.g., second user 110b's field of view) to ad platform 1904.

In step 1926, ad platform 1904 identifies and locates a trigger object in the other user's field of view (e.g., second user 110b's field of view) that matches the full ad shown to the user (e.g., first user 110a, John 702a).

In step 1928, second sensors equipped XR display 1906 displays the full ad (e.g., first media content item 114, full ad 704) that matches the full ad shown to the user (e.g., first user 110a, John 702a), to the other user (e.g., second user 110b, Mike 702b).

In step 1930, first sensors equipped XR display 1902 (e.g., first user's XR device) forwards additional sensor-collected data relating to the user's field of view (e.g., first user 110a's field of view) to ad platform 1904.

In step 1932, ad platform 1904 identifies and locates the trigger object matching the full ad previously shown to the user (e.g., first user 110a, John 702a) and to the other user (e.g., second user 110b, Mike 702b) in the additional sensor-collected data.

In step 1934, first sensors equipped XR display 1902 displays a reminder ad (e.g., second media content item 116, reminder ad 716) related to the full ad, to the user (e.g., first user 110a, John 702a). The reminder ad comprises content of the full ad.

In step 1936, second sensors equipped XR display 1906 (e.g., second user's XR device) forwards additional sensor-collected data relating to the other user's field of view (e.g., first user 110a's field of view) to ad platform 1904.

In step 1938, ad platform 1904 identifies and locates the trigger object matching the full ad previously shown to the other user (e.g., second user 110b, Mike 702b) and to the other user (e.g., second user 110b, Mike 702b) in the additional sensor-collected data.

In step 1940, ad platform 1904 displays a reminder ad to the other user (e.g., second user 110b, Mike 702b). The predicted future interaction occurs after the viewing of reminder ads by the user (e.g., first user 110a, John 702a) and the other user (e.g., second user 110b, Mike 702b).

Alternatively, a different sequence of steps (not shown on FIG. 19) may occur. From step 1912 to step 1928, the different sequence of steps follows the above sequence of steps. Then, in response to step 1928, step 1934 occurs followed by steps 1936 to 1940 and subsequently by the predicted future interaction.

Here is another example where the methods and systems described in the present disclosure can be used, e.g.: the Football Example.

Suppose Nigel and Robin are two English football fans who went to school at Leeds. They played together and their love of football has kept them together though they don't live near each other and work in different professions. Nigel is a Liverpool fan and Robin is a Manchester United fan. Suppose the Australian brand Vegemite® is trying to expand into England. Nigel and Robin have already matched the criteria for the Vegemite®.

In traditional media settings, Nigel and Robin watch games of their respective clubs. Today, Liverpool is playing Manchester United. Both Nigel and Robin are watching this game at their respective homes. They both have interactive TV and can chat with their friends while they watch a show. Methods and systems for presenting ads to multiple users prior to a predicted future interaction in accordance with some implementations of the disclosure will show at least one of them a reminder ad for Vegemite® (having previously shown them both full ads) to prompt a discussion during the predicted future interaction. Nigel says “I'm going to get me some Vegemite® for me chips.” Robin says “Didn't know you were trying it. I will bet you a jar if Liverpool has a lead at the end of the first half and a four-pack if they win!”

In social media settings, Nigel and Robin participate in a Facebook® group of old members of the football club at Leeds from 1999. They might discuss football history and debate some controversial parts of it, such as who was the best center forward ever. But the group members know each other well through social media and share thoughts on other topics as well.

With the methods and systems for presenting ads to multiple users prior to a predicted future interaction in accordance with some implementations of the disclosure, Facebook® can anticipate that they are more likely to interact in the football group because a big game is coming up. Therefore, Facebook® will use the methods and systems for presenting ads to multiple users prior to a predicted future interaction in accordance with some implementations of the disclosure to show at least one of them a reminder ad for Vegemite® (having previously shown them both full ads).

In XR settings, Nigel and Robin decided to meet for dinner after the Liverpool versus Manchester United match. Robin knows a good restaurant in Manchester that is far enough from the stadium that they won't have to contend with too much of a football crowd. The XR platform shows them reminder ads for Vegemite®, possibly when the game is over and they are heading out of the stadium.

In some implementations, the proximity of the users is taken into account while presenting the reminder ad. The proximity may be social or geographic. Geographic proximity is when the users are likely to be in the same physical location. Social proximity is when the users are strongly connected on social media. Being connected over various channels, greater frequency of interactions, etc. signal higher proximity. Being part of the same groups on Facebook®, being seen in the same Spaces on Twitter® or following the same persons on IG® can be an equivalent indication of social proximity.

By taking the proximity of users into account for presenting the reminder ad, the methods and systems for presenting ads to multiple users prior to a predicted future interaction in accordance with some implementations of the disclosure sets the stage for the involved users to broach the subject and impact each other's thinking.

In some implementations, the reminder ads may be shown to the first user only if both the first and the second users have positive reactions to the ad. Reactions can be measured by biometrics from their devices, positive terms used in response to the ad, etc.

The methods and systems for presenting ads to multiple users prior to a predicted future interaction in accordance with some implementations of the disclosure applies iteratively. Specifically, if a third user in one of their social circles comes across the trigger object, a reminder ad is generated. When all three users are in the same social circle, reminders go out to both the first and the second user.

In some implementations, some limitations are included in the frequency of the presentation of the reminder ads to the first and second users so as to ensure that they are not generated in excess. For example, we can require that a reminder ad is shown only if the corresponding full ad has not been shown for a sufficiently long period and if there is a long enough gap between successive reminder ads (e.g., several hours or days).

In some implementations, trigger objects could be specified or ranked for the reminder ads. For example, if the reminder ad is for a car, the trigger object could be that car; for a luxury item such as a wristwatch, the trigger object could be the storefront of a luxury handbag store. The selection of trigger objects is up to the ad agency and is not included in the methods and systems for presenting ads to multiple users prior to a predicted future interaction in accordance with some implementations of the disclosure. The selection of trigger objects may be user-dependent and/or ad-dependent.

In some implementations, the topical history is used to determine relevant social contacts for ads. For example, the first user may be an IT professional may be looking for a product and he may be shown an advertisement for Atlassian® products. The first user may share the product topic with some of his work colleagues but not others. Only second users who share this topic with the first user will be presented full ads and related reminder ads. It is quite possible that there are other users who are targets for the ad but do not share the topical history related to the product. These may be team members belonging to different business units, product teams, etc.

In some implementations, the reminder ad being presented to multiple users may be a brand advertisement. In some implementations, the reminder ad being presented to multiple users may be a full advertisement.

In some implementations, multiple users (e.g., other members of the social circle of first and second users), besides first and second users, may be presented ads prior to a predicted future interaction.

In some implementations, a more restrictive version is to show the reminder ad only when the specified trigger object becomes visible. This is suitable when the trigger objects are common so that a match is likely. For rarer trigger objects, the chances of a match would be low and make the reminder ad less likely to appear in time.

In some implementations, if the ad does not meet a threshold, it should not be displayed at all. This is because users get tired of seeing the same ads repeatedly, so the reminder ad is shown and has significant value.

In some implementations, the reminder ad may be accompanied by a message that the ad was shown to another user.

In some implementations, for XR settings, the suitability score for each ad and each user predicted future interaction is calculated as (T^{α}*D^{β}*A^{γ})/P^{δ}. Here, α, β, γ, and δ are parameters that can be adjusted to meet the requirements of a specific setting.

Independence of group size: In some implementations for the social media case, the suitability score S for each ad and each user predicted future interaction is calculated as (T²*R*A), e.g., without the inverse dependence on P.

In some implementations, users may opt out of getting reminder ads.

In some implementations, the user may specify bids on the full ad and the related reminder ads. The bid amount will help determine which ads are actually presented to multiple users.

In addition, specific parameters for showing reminder ads may be combined with the methods and systems described in the present disclosure. These parameters may include user criteria, market criteria, second user criteria, etc.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
causing, using control circuitry, a first media content item to be presented to a first user and a second user;
determining, using control circuitry, whether each of the first and second users has consumed the first media content item;
determining, using control circuitry, in response to determining that each of the first and second users has consumed the first media content item, a predicted future interaction between the first user and the second user; and
causing, using control circuitry, in response to determining the predicted future interaction between the first user and the second user, a second media content item to be presented to each of the first and second users prior to the predicted future interaction, wherein the second media content item comprises content relating to the first media content item.

2. The method of claim 1, wherein causing the first media content item to be presented to each of the first and second users comprises:
determining first user information relating to the first user;
determining second user information relating to the second user;
determining whether each of the first and second user information corresponds to a parameter of the first media content item; and
causing, in response to determining that each of the first and second user information corresponds to the parameter of the first media content item, the first media content item to be presented to each of the first and second users.

3. The method of claim 1, wherein causing the first media content item to be presented to each of the first and second users comprises:
determining whether a trigger object is in a field of view of each of the first and second users; and
causing, in response to determining that the trigger object is in the field of view of each of the first and second users, the first media content item to be presented to each of the first and second users.

4. The method of claim 1, wherein determining the predicted future interaction between the first and second users comprises:
determining first user information relating to the first user, wherein the first user information comprises at least one of calendar data, geolocation data or virtual location data of the first user, or online comments of the first user;
determining second user information relating to the second user, wherein the second user information comprises at least one of calendar data, geolocation data or virtual location data of the second user or online comments of the second user; and
determining the predicted future interaction based on the first and second user information.

5. The method of claim 4, the method further comprising:
determining whether the first and second users each belong to a social circle based on the first and second user information; and
causing, in response to determining that the first and second users each belong to the social circle, the second media content item to be presented to each of the first and second users prior to the predicted future interaction.

6. The method of claim 1, wherein causing the second media content item to be presented to each of the first and second users prior to the predicted future interaction further comprises:
determining a duration of the second media content item; and
causing the second media content item to be presented to each of the first and second users at a first point in time spaced before the predicted future interaction by at least the duration.

7. The method of claim 6, wherein causing the second media content item to be presented to each of the first user and the second user at the first point in time spaced before the predicted future interaction by at least the duration further comprises:
determining a first convenient point in time for the first user using the first user information, and a second convenient point in time for the second user using the second user information, wherein each of the first and second convenient points in time precede the first point in time, and the first and second convenient points in time are different from each other; and
causing the second media content item to be presented to the first user at the first convenient point and to the second user at the second convenient point.

8. The method of claim 7, wherein causing the second media content item to be presented to the first user at the first convenient point in time and to the second user at the second convenient point in time further comprises:
determining a first window of time of the first user and a second window of time of the second user, each of the first and second windows of time having a start point and an end point in time;
determining a second point in time indicating a start of the predicted future interaction, wherein the end point of each of the first and second windows of time and the second point match one another;
setting the first convenient point in time in between the start point of the first window of time and the first point in time and setting the second convenient point in time in between the start point of the second window of time and the first point in time.

9. The method of claim 1, wherein causing the second media content item to be presented to each of the first and second users prior to the predicted future interaction further comprises:
determining, in response to determining that each of the first and second users has consumed the first media content item, a positive response of the first user and a positive response of the second user to the first media content item;
determining whether each of the positive response of the first user and the positive response of the second user has exceeded a positive response threshold; and
causing, in response to determining that each of the positive response of the first user and the positive response of the second user has exceeded the positive response threshold, the second media content item to be presented to each of the first and second users prior to the predicted future interaction.

10. The method of claim 1, wherein:
causing the first media content item to be presented to a first user and a second user further comprises setting a lifetime of the first media content item;
determining the predicted future interaction between the first user and the second user further comprises determining a plurality of predicted future interactions between the first user and the second user; and
causing the second media content item to be presented to each of the first and second users prior to the predicted future interaction further comprises:
determining a time gap between each two successive predicted future interactions of the plurality of the predicted future interactions;
mapping each predicted future interaction to each time gap, preceding and adjacent to each predicted future interaction;
setting a presentation threshold related to the second media content item based on the lifetime of the first media content item;
determining whether each time gap exceeds the presentation threshold; and
causing the second media content item to be presented to each of the first and second users prior to each predicted future interaction, wherein the mapped time gap exceeds the presentation threshold.

11. A system comprising control circuitry configured to:
cause a first media content item to be presented to a first user and a second user;
determine whether each of the first and second users has consumed the first media content item;
determine, in response to determining that each of the first and second users has consumed the first media content item, a predicted future interaction between the first user and the second user; and
cause, in response to determining the predicted future interaction between the first user and the second user, a second media content item to be presented to each of the first and second users prior to the predicted future interaction, wherein the second media content item comprises content relating to the first media content item.

12. The system of claim 11, wherein, when causing the first media content item to be presented to each of the first and second users, control circuitry is configured to:
determine first user information relating to the first user;
determine second user information relating to the second user;
determine whether each of the first and second user information corresponds to a parameter of the first media content item; and
cause, in response to determine that each of the first and second user information corresponds to the parameter of the first media content item, the first media content item to be presented to each of the first and second users.

13. The system of claim 11, wherein, when causing the first media content item to be presented to each of the first and second users, control circuitry is configured to:
determine whether a trigger object is in a field of view of each of the first and second users; and
cause, in response to determine that the trigger object is in the field of view of each of the first and second users, the first media content item to be presented to each of the first and second users.

14. The system of claim 11, wherein, when determining the predicted future interaction between the first and second users, control circuitry is configured to:
determine first user information relating to the first user, wherein the first user information comprises at least one of calendar data, geolocation data or virtual location data of the first user, or online comments of the first user;
determine second user information relating to the second user, wherein the second user information comprises at least one of calendar data, geolocation data or virtual location data of the second user or online comments of the second user; and
determine the predicted future interaction based on the first and second user information.

15. The system of claim 14, wherein, when determining the predicted future interaction between the first and second users, control circuitry is further configured to:
determine whether the first and second users each belong to a social circle based on the first and second user information; and
cause, in response to determine that the first and second users each belong to the social circle, the second media content item to be presented to each of the first and second users prior to the predicted future interaction.

16. The system of claim 11, wherein, when causing the second media content item to be presented to each of the first and second users prior to the predicted future interaction, control circuitry is configured to:
determine a duration of the second media content item; and
cause the second media content item to be presented to each of the first and second users at a first point in time spaced before the predicted future interaction by at least the duration.

17. The system of claim 16, wherein, when causing the second media content item to be presented to each of the first user and the second user at the first point in time spaced before the predicted future interaction by at least the duration, control circuitry is configured to:
determine a first convenient point in time for the first user using the first user information, and a second convenient point in time for the second user using the second user information, wherein each of the first and second convenient points in time precede the first point in time, and the first and second convenient points in time are different from each other; and
cause the second media content item to be presented to the first user at the first convenient point and to the second user at the second convenient point.

18. The system of claim 17, wherein, when causing the second media content item to be presented to the first user at the first convenient point in time and to the second user at the second convenient point in time, control circuitry is configured to:
determine a first window of time of the first user and a second window of time of the second user, each of the first and second windows of time having a start point and an end point in time;
determine a second point in time indicating a start of the predicted future interaction, wherein the end point of each of the first and second windows of time and the second point match one another;
set the first convenient point in time in between the start point of the first window of time and the first point in time and set the second convenient point in time in between the start point of the second window of time and the first point in time.

19. The system of claim 11, wherein when causing the second media content item to be presented to each of the first and second users prior to the predicted future interaction, control circuitry is configured to:
determine, in response to determine that each of the first and second users has consumed the first media content item, a positive response of the first user and a positive response of the second user to the first media content item;
determine whether each of the positive response of the first user and the positive response of the second user has exceeded a positive response threshold; and
cause, in response to determine that each of the positive response of the first user and the positive response of the second user has exceeded the positive response threshold, the second media content item to be presented to each of the first and second users prior to the predicted future interaction.

20. The system of claim 11, wherein,
when causing the first media content item to be presented to a first user and a second user, control circuitry is configured to set a lifetime of the first media content item;
when determining the predicted future interaction between the first user and the second user, control circuitry is configured to determine a plurality of predicted future interactions between the first user and the second user; and
when causing the second media content item to be presented to each of the first and second users prior to the predicted future interaction, control circuitry is configured to:
determine a time gap between each two successive predicted future interactions of the plurality of the predicted future interactions;
map each predicted future interaction to each time gap, preceding and adjacent to each predicted future interaction;
set a presentation threshold related to the second media content item based on the lifetime of the first media content item;
determine whether each time gap exceeds the presentation threshold; and
cause the second media content item to be presented to each of the first and second users prior to each predicted future interaction, wherein the mapped time gap exceeds the presentation threshold.

21-50. (canceled)
